(19) United States
(12) Patent Application Publication
(10) Pub. No.: US 2022/0374563 A1
(43) Pub. Date: Nov. 24, 2022

(54) METHOD FOR SIMULATING CHATTER-FREE MILLED SURFACE TOPOGRAPHY

(71) Applicant: DALIAN UNIVERSITY OF TECHNOLOGY, Dalian, Liaoning (CN)

(72) Inventors: Jinbo NIU, Dalian, Liaoning (CN); Yuwen SUN, Dalian, Liaoning (CN); Dongming GUO, Dalian, Liaoning (CN)

(21) Appl. No.: 17/422,099

(22) PCT Filed: Mar. 6, 2020
(86) PCT No.: PCT/CN2020/078137

§ 371 Date: Jul. 9, 2021

(51) Int. Cl. G06F 30/20

(52) U.S. Cl. CPC G06F 30/20; G06F 2111/10

(57) ABSTRACT

Method for simulating chatter-free milled surface topography includes: performing dynamics modeling on milling system and building delay differential equation with multiple delays to represent dynamic model; constructing state transition matrix between two adjacent cutting tool rotation periods by extending GRK method; predicting stable milling parameter zones based on Floquet theory; calculating vibration displacements on discretized time nodes during one cutting tool rotation period by means of fixed mapping point theorem; constructing motion trajectories of cutting tool edges in normal and feed directions with regard to milled surface of workpiece; predicting surface topography of workpiece by using spline interpolation to densify motion trajectories of cutting tool edges that participate in generating final surface of workpiece; calculating surface location error of milled surface based on motion trajectories of cutting tool edges in normal direction with regard to milled surface of workpiece; calculating surface roughness based on the simulated surface topography of workpiece.

### FIELD OF THE INVENTION

The invention relates to mechanical machining, and more specifically, to a method for simulating chatter-free milled surface topography.

### BACKGROUND

Topography of milled surfaces is generated by complicated interaction between cutting tool and workpiece during machining process. In order to achieve qualified milled surface, it is a prerequisite to avoid regenerative milling chatter, which is a kind of self-excited strong vibrations. Nevertheless, chatter-free milling does not mean high-quality milling. Surface location error and surface roughness are closely related to tool geometry (pitch angles, helix angles, number of teeth etc.), cutting conditions (tool runout) and process parameters (spindle rotation speed, feed per tooth, radial/axial depth of cut etc.).

Currently, initial value based time-domain simulation method is the only way to simultaneously predicting chatter stability, surface location error and surface roughness for milling operations, as reported in REF. 1 (Schmitz, T. L., and Smith, K. S., 2009, Machining Dynamics, Springer US, Boston, Mass.). However, the initial value based time-domain simulation method suffers from low computational efficiency, which prevents its wide application in industry.

REF 2 (Niu, J., Ding, Y, Zhu, L., and Ding, H., 2014, Runge-Kutta Methods for a Semi Analytical Prediction ofMilling Stability, Nonlinear Dynamics, 76(1), pp. 289-304) presented a semi-analytical method (i.e., Generalized Runge-Kutta (GRK) method) for stability analysis of milling operations using tools with constant pitch and constant helix angles, and omitting influences of tool runout, which is of high computational accuracy and efficiency. REF. 3 (Niu, J., Ding, Y, Zhu, L., and Ding, H., 2017, Mechanics and Multi-Regenerative Stability of Variable Pitch and Variable Helix Milling Tools Considering Runout, Int. J. Mach. Tools Manuf., 123, pp. 129-145) extended the GRK method in REF. 2 to predicting stability of milling operations using variable pitch and variable helix tools and considering effect of runout. Nevertheless, both REF. 2 and REF. 3 omitted steady cutting force term that does not affect chip regeneration. As a result, the methods in REF. 2 and REF. 3 cannot be used directly for predicting surface location error and surface roughness of milled surface, and cannot be used for simulating surface topography either.

Chinese patents with publication numbers CN102490081B, CN103713576B and CN108515217B also proposed different methods to simulate milled surface topography. However, only kinematic motions were taken into account in these patents, and influences of cutting vibrations were neglected.

In conclusion, it is necessary to propose a method for simulating chatter-free milled surface topography, which can predict chatter stability, surface location error and surface roughness simultaneously. It is of great significance for avoidance of cutting chatter and improvement of cutting quality.

### SUMMARY

This invention discloses a method for simulating chatter-free milled surface topography. Its basic idea is: achieving chatter-free cutting parameters by means of dynamics modeling and stability analysis of milling system; calculating relative vibration displacements between cutting tool and workpiece by extending the GRK method; obtaining motion trajectories of cutting tool edges by means of kinematic synthesis of feed movements along tool path, rotations around spindle axis and dynamic vibrations of milling system; and finally obtaining milled surface topography by means of Boolean operation on envelope of cutting tool edge trajectories and workpiece block.

This invention is implemented by following technical solutions.

A method for simulating chatter-free milled surface topography, comprising steps of:

step 1: performing dynamics modeling on milling system and building a delay differential equation with multiple delays to represent dynamic model;

step 2: constructing state transition matrix between two adjacent cutting tool rotation periods by extending Generalized Runge-Kutta method;

step 3: predicting stable milling parameter zones based on Floquet theory;

step 4: calculating vibration displacements on discretized time nodes during one cutting tool rotation period by means of fixed mapping point theorem;

step 5: constructing motion trajectories of cutting tool edges in normal and feed directions with regard to milled surface of workpiece;

step 6: predicting surface topography of workpiece by using spline interpolation to densify motion trajectories of cutting tool edges that participate in generating final surface of workpiece;

step 7: calculating surface location error of milled surface based on motion trajectories of cutting tool edges in normal direction with regard to milled surface of workpiece;

step 8: calculating surface roughness based on the simulated surface topography of workpiece.

The step 1 comprises sub-steps of:

step 1.1: considering flexibility of both cutting tool and workpiece, variance of pitch angles and helix angles of cutting tool, and teeth runout, perform dynamics modeling on milling system and build a delay differential equation with multiple delays to represent the dynamic model in physical space:

$$M \ddot{q} ( t ) + C \dot{q} ( t ) + K q ( t ) = {\sum }_{k = 1}^{N} {\sum }_{j = 1}^{{N}_{a}} \{ {K}_{c} ( t , j , k ) [ q ( t ) - q ( t - {\sum }_{p = {k}_{v}}^{k} τ ( j , p ) ) ] + {F}_{0} ( t , j , k ) \}$$

where M, C and K are mass, damping and stiffness matrices, respectively; \ddot{q}(t), \dot{q}(t) and q(t) are acceleration, velocity and displacement vectors at time t, respectively; K_{c}(t,j,k) is directional coefficient matrix for Tooth k at j-th axial slice at time t; F₀(t,j,k) is cutting force vector for Tooth k at j-th axial slice at time t, which is independent of chip regeneration; Σₚ₌ₖ_{ᵥ}^{k} τ(j,p) is time delay with regard to cutting element (j,k), Σ is mathematical summation operator, p is a variable for summation, and kᵥ is tooth serial number to start delay calculation; N is number of teeth; and Nₐ is number of axial discretization of tool;

step 1.2: perform modal coordinate transformation on the dynamic model in step 1.1, which can be transformed from physical space into modal space; the modal coordinate transformation equation is:

q(t)=PΓ(t)

where P is the mode shape matrix, and Γ(t) is the modal displacement at time t;

dynamics model in modal space which is represented with delay differential equation with multiple delays turns out to be:

$${M}_{Γ} \ddot{Γ} ( t ) + {C}_{Γ} \dot{Γ} ( t ) + {K}_{Γ} Γ ( t ) = {{\sum }^{N}}_{k = 1} {\sum }_{j = 1}^{{N}_{a}} \{ {P}^{T} {K}_{c} ( t , j , k ) P [ Γ ( t ) - Γ ( t - {\sum }_{p = {k}_{v}}^{k} τ ( j , p ) ) ] + {P}^{T} {F}_{0} ( t , j , k ) \}$$

where M_{Γ}, C_{Γ} and K_{Γ} are modal mass, modal damping and modal stiffness matrices, respectively; \hat{Γ}(t), \dot{Γ}(t) and Γ(t) are modal acceleration, modal velocity and modal displacement vectors, respectively;

for milling system with flexible cutting tool and flexible workpiece, the dynamic model becomes:

$$[ \begin{matrix}{M}_{Γ ; T} & \\ & {M}_{Γ ; W}\end{matrix} ] \{ \begin{matrix}{\ddot{Γ}}_{T} ( t ) \\ {\ddot{Γ}}_{W} ( t )\end{matrix} \} + [ \begin{matrix}{C}_{Γ ; T} & \\ & {C}_{Γ ; W}\end{matrix} ] \{ \begin{matrix}{\dot{Γ}}_{T} ( t ) \\ {\dot{Γ}}_{W} ( t )\end{matrix} \} + [ \begin{matrix}{K}_{Γ ; T} & \\ & {K}_{Γ ; W}\end{matrix} ] \{ \begin{matrix}{Γ}_{T} ( t ) \\ {Γ}_{W} ( t )\end{matrix} \} = {\sum }_{k = 1}^{N} {\sum }_{j = 1}^{{N}_{a}} \{ [ \begin{matrix}{P}_{T}^{T} \\ - {P}_{W}^{T}\end{matrix} ] {K}_{c} ( t , j , k ) [ \begin{matrix}{P}_{T} & - {P}_{W}\end{matrix} ] \{ \begin{matrix}{Γ}_{T} ( t ) - {Γ}_{T} ( t - {\sum }_{p = {k}_{v}}^{k} τ ( j , p ) ) \\ {Γ}_{W} ( t ) - {Γ}_{W} ( t - {\sum }_{p = {k}_{v}}^{k} τ ( j , p ) )\end{matrix} \} + [ \begin{matrix}{P}_{T}^{T} \\ - {P}_{W}^{T}\end{matrix} ] {F}_{0} ( t , j , k ) \}$$

where m_{Γ;T}, C_{Γ;T} and K_{Γ;T} are modal mass, modal damping and modal stiffness matrices of cutting tool; M_{Γ;W}, C_{Γ;W} and K_{Γ;W} are modal mass, modal damping and modal stiffness matrices of workpiece; \ddot{Γ}_{T}(t), \dot{Γ}_{T} (t) and Γ_{T}(t) are modal acceleration, modal velocity and modal displacement vectors of cutting tool; \ddot{Γ}_{W}(t), \dot{Γ}_{W}(t) and Γ_{W}(t) are modal acceleration, modal velocity and modal displacement vectors of workpiece; P_{T} and P_{W} are mode shape matrices of cutting tool and workpiece, respectively; P_{T}^{T} and P_{W}^{T} are transposed matrices of P_{T} and P_{W}, respectively;

for milling system with flexible cutting tool and rigid workpiece, the dynamic model becomes:

$${M}_{Γ ; T} {\ddot{Γ}}_{T} ( t ) + {C}_{Γ ; T} {\dot{Γ}}_{T} ( t ) + {K}_{Γ ; T} {Γ}_{T} ( t ) = {\sum }_{k = 1}^{N} {\sum }_{j = 1}^{{N}_{a}} \{ {P}_{T}^{T} {K}_{c} ( t , j , k ) \{ {P}_{T} [ {Γ}_{T} ( t ) - {Γ}_{T} ( t - {\sum }_{p = {k}_{v}}^{k} τ ( j , p ) ) ] \} + {P}_{T}^{T} {F}_{0} ( t , j , k ) \}$$

for milling system with rigid cutting tool and flexible workpiece, the dynamic model becomes:

$${M}_{Γ ; W} {\ddot{Γ}}_{W} ( t ) + {C}_{Γ ; W} {\dot{Γ}}_{W} ( t ) + {K}_{Γ ; W} {Γ}_{W} ( t ) = {\sum }_{k = 1}^{N} {\sum }_{j = 1}^{{N}_{a}} \{ {P}_{W}^{T} {K}_{c} ( t , j , k ) \{ {P}_{W} [ {Γ}_{W} ( t ) - {Γ}_{W} ( t - {\sum }_{p = {k}_{v}}^{k} τ ( j , p ) ) ] \} - {P}_{W}^{T} {F}_{0} ( t , j , k ) \} .$$

The step 2 comprises sub-steps of:

step 2.1: perform state space transformation on the dynamic model in modal space by introducing state variable vector x(t)=[(Γ(t))^{T},(\dot{Γ}(t))^{T}]^{T}, and delay differential equation with multiple delays in state space becomes:

$$\dot{x} ( t ) = A x ( t ) + {\sum }_{k = 1}^{N} {\sum }_{j = 1}^{{N}_{a}} \{ B ( t , j , k ) [ x ( t ) - x ( t - {\sum }_{p = {k}_{v}}^{k} τ ( j , p ) ) ] + D ( t , j , k ) \}$$

where x(t) denotes state variable vector, \dot{x}(t) denotes first derivative of x(t) with regard to time t,

$$A = [ \begin{matrix}0 & I \\ - {M}_{Γ}^{- 1} {K}_{Γ} & - {M}_{Γ}^{- 1} {C}_{Γ}\end{matrix} ] ,$$

$$B ( t , j , k ) = [ \begin{matrix}0 & 0 \\ {M}_{Γ}^{- 1} {P}^{T} {K}_{c} ( t , j , k ) P & 0\end{matrix} ] ,$$

$$D ( t , j , k ) = [ \begin{matrix}0 \\ {M}_{Γ}^{- 1} {P}^{T} {F}_{0} ( t , j , k )\end{matrix} ] ,$$

and I is unit matrix;

step 2.2: divide one rotation period of cutting tool T into 2iₘ+2 equal intervals with a series of discrete nodes {t₀,t₁, . . . ,t₂ᵢ_{ₘ}₊₂}; analytical expression of dynamic responses at interval [tᵢ,t] with regard to the delay differential equation with multiple delays in step 2.1 is:

$$x ( t ) = {e}^{A ( t - {t}_{i} )} x ( {t}_{i} ) + {\sum }_{k = 1}^{N} {\sum }_{j = 1}^{{N}_{a}} {\int }_{{t}_{i}}^{t} \{ {e}^{A ( t - ξ )} B ( ξ , j , k ) [ x ( ξ ) - x ( ξ - {\sum }_{p = {k}_{v}}^{k} τ ( j , p ) ) ] + {e}^{A ( t - ξ )} D ( ξ , j , k ) \} d ξ$$

where ξ is integration variable.

for brevity, define xᵢ:=x(tᵢ), E(t,tᵢ):=e^{A(t-t}i⁾x(tᵢ), H_{j,k}(t,ξ,x(ξ):=e^{A(t-ξ)}B(ξ,j,k)[x(ξ)−x(ξ−τ(j,k,p))] and J_{j,k}(t,ξ):=e^{A(t-ξ)}D(ξ,j,k); on sub-interval [t₂ᵢ,t₂ᵢ₊₂], x(t) is approximated using Simpson's rule:

$${x}_{2 i + 2} = E ( {t}_{2 i + 2} , {t}_{2 i} ) + \frac{h}{3} {\sum }_{k = 1}^{N} {\sum }_{j = 1}^{{N}_{a}} \{ {H}_{j , k} ( {t}_{2 i + 2} , {t}_{2 i} , {x}_{2 i} ) + 4 {H}_{j , k} ( {t}_{2 i + 2} , {t}_{2 i + 1} , {x}_{2 i + 1} ) + {H}_{j , k} ( {t}_{2 i + 2} , {t}_{2 i + 2} , {x}_{2 i + 2} ) + {J}_{j , k} ( {t}_{2 i + 2} , {t}_{2 i} ) + 4 {J}_{j , k} ( {t}_{2 i + 2} , {t}_{2 i + 1} ) + {J}_{j , k} ( {t}_{2 i + 2} , {t}_{2 i + 2} ) \}$$

on sub-interval [t₂ᵢ,t₂ᵢ₊₁], x(t) is approximated using fourth-order Runge-Kutta algorithm:

$${x}_{2 i + 1} = E ( {t}_{2 i + 1} , {t}_{2 i} ) + \frac{h}{6} {\sum }_{k = 1}^{N} {\sum }_{j = 1}^{{N}_{a}} \{ {H}_{j , k} ( {t}_{2 i + 1} , {t}_{2 i} , {x}_{2 i} ) + 2 {H}_{j , k} ( {t}_{2 i + 1} , {t}_{2 i + 1 / 2} , {x}_{2 i + 1 / 2} ) + 2 {H}_{j , k} ( {t}_{2 i + 1} , {t}_{2 i + 1 / 2} , {x}_{2 i + 1 / 2} ) + {H}_{j , k} ( {t}_{2 i + 1} , {t}_{2 i + 1} , {x}_{2 i + 1} ) + {J}_{j , k} ( {t}_{2 i + 1} , {t}_{2 i} ) + 2 {J}_{j , k} ( {t}_{2 i + 1} , {t}_{2 i + 1 \text{/2}} ) + 2 {J}_{j , k} ( {t}_{2 i + 1} , {t}_{2 i + 1 / 2} ) + {J}_{j , k} ( {t}_{2 i + 1} , {t}_{2 i + 1} ) \}$$

where state variable vector at middle points t_{2i+1/2} is approximated with Lagrange formula:

x₂ᵢ₊½=⅜x₂ᵢ+¾x₂ᵢ₊₁⅛x₂ᵢ₊₂

the analytical expression of dynamic responses on sub-interval [t₂ᵢ,t₂ᵢ₊₁] is re-organized into:

$${F}_{2 i} {x}_{2 i} + {F}_{2 i + 1} {x}_{2 i + 1} + {F}_{2 i + 2} {x}_{2 i + 2} = {\sum }_{k = 1}^{N} {\sum }_{j = 1}^{{N}_{a}} ( {F}_{2 i - τ ( j , k )} {x}_{2 i - τ ( j , k )} + {F}_{2 i + 1 - τ ( j , k )} {x}_{2 i + τ ( j , k )} + {F}_{2 i + 2 - τ ( j , k )} {x}_{2 i + 2 - τ ( j , k )} ) + {\sum }_{k = 1}^{N} {\sum }_{j = 1}^{{N}_{a}} ( {S}_{2 i} + {S}_{2 i + 1 / 2} + {S}_{2 i + 1} )$$

$$where$$

$${F}_{2 i} = - {e}^{A h} - \frac{h}{6} {e}^{A h} {\sum }_{k = 1}^{N} {\sum }_{j = 1}^{{N}_{a}} {B}_{2 i , j , k} - \frac{3}{8} \cdot \frac{4 h}{6} {e}^{Ah / 2} {\sum }_{k = 1}^{N} {\sum }_{j = 1}^{{N}_{a}} {B}_{2 i + 1 / 2 , j , k} ,$$

$${F}_{2 i + 1} = I - \frac{3}{4} \cdot \frac{4 h}{6} {e}^{Ah / 2} {\sum }_{k = 1}^{N} {\sum }_{j = 1}^{{N}_{a}} {B}_{2 i + 1 / 2 , j , k} - \frac{h}{6} {\sum }_{k = 1}^{N} {\sum }_{j = 1}^{{N}_{a}} {B}_{2 i + 1 , j , k} ,$$

$${F}_{2 i + 2} = \frac{1}{8} \cdot \frac{4 h}{6} {e}^{Ah / 2} {\sum }_{k = 1}^{N} {\sum }_{j = 1}^{{N}_{a}} {B}_{2 i + 1 / 2 , j , k} ,$$

$${F}_{2 i - τ ( j , k , p )} = - \frac{h}{6} {e}^{A h} {B}_{2 i , j , k} - \frac{3}{8} \cdot \frac{4 h}{6} {e}^{Ah / 2} {B}_{2 i + 1 / 2 , j , k} ,$$

$${F}_{2 i + 1 - τ ( j , k , p )} = - \frac{3}{4} \cdot \frac{4 h}{6} {e}^{Ah / 2} {B}_{2 i + 1 / 2 , j , k} - \frac{h}{6} {B}_{2 i + 1 , j , k} ,$$

$${F}_{2 i + 2 - τ ( j , k , p )} = \frac{1}{8} \cdot \frac{4 h}{6} {e}^{Ah / 2} {B}_{2 i + 1 / 2 , j , k} ,$$

$${S}_{2 i} = \frac{h}{6} {e}^{A \cdot h} {D}_{2 i , j , k} ,$$

$${S}_{2 i + 1 / 2} = \frac{h}{6} \cdot 4 {e}^{A \cdot h / 2} {D}_{2 i + 1 / 2 , j , k} ,$$

$${S}_{2 i + 1} = \frac{h}{6} {D}_{2 i + 1 , j , k} ,$$

and h is discretization step;

the analytical expression of dynamic responses on sub-interval [t₂ᵢ,t₂ᵢ₊₂] is re-organized into:

$${G}_{2 i} {x}_{2 i} + {G}_{2 i + 1} {x}_{2 i + 1} + {G}_{2 i + 2} {x}_{2 i + 2} = {\sum }_{k = 1}^{N} {\sum }_{j = 1}^{{N}_{a}} ( {G}_{2 i - τ ( j , k )} {x}_{2 i - τ ( j , k )} + {G}_{2 i + 1 - τ ( j , k )} {x}_{2 i + 1 - τ ( j , k )} + {G}_{2 i + 2 - τ ( j , k )} {x}_{2 i + 2 - τ ( j , k )} ) + {\sum }_{k = 1}^{N} {\sum }_{j = 1}^{{N}_{a}} ( {T}_{2 i} + {T}_{2 i + 1} + {T}_{2 i + 2} )$$

$$where$$

$${G}_{2 i} = - {e}^{2 A h} - \frac{h}{3} {e}^{2 A h} {\sum }_{k = 1}^{N} {\sum }_{j = 1}^{{N}_{a}} {B}_{2 i , j , k} ,$$

$${G}_{2 i + 1} = - \frac{4 h}{3} {e}^{A h} {\sum }_{k = 1}^{N} {\sum }_{j = 1}^{{N}_{a}} {B}_{2 i + 1 , j , k} ,$$

$${G}_{2 i + 2} = I - \frac{h}{3} {\sum }_{k = 1}^{N} {\sum }_{j = 1}^{{N}_{a}} {B}_{2 i + 2 , j , k} ,$$

$${G}_{2 i - τ ( j , k , p )} = - \frac{h}{3} {e}^{2 A h} {B}_{2 i , j , k} ,$$

$${G}_{2 i + 1 - τ ( j , k , p )} = - \frac{4 h}{3} {e}^{A h} {B}_{2 i + 1 , j , k} ,$$

$${G}_{2 i + 2 - τ ( j , k , p )} = - \frac{h}{3} {B}_{2 i + 2 , j , k} ,$$

$${T}_{2 i} = \frac{h}{3} {e}^{A \cdot 2 h} {D}_{2 i , j , k} ,$$

$${T}_{2 i + 1} = \frac{h}{3} \cdot 4 {e}^{A \cdot h} {D}_{2 i + 1 , j , k}$$

$$and$$

$${T}_{2 i + 2} = \frac{h}{3} {D}_{2 i + 2 , j , k} ;$$

step 2.3: based on the formulae in step 2.2, discrete mapping relationship between two adjacent rotation periods of cutting tool [−T,0] and [0,T] is established:

$${P}_{1} {y}_{[ 0 , T ]} = {Qy}_{[ - T , 0 ]} + {P}_{2} {y}_{[ 0 , T ]} + {z}_{[ 0 , T ]}$$

$$where$$

$${y}_{[ 0 , T ]} = [ \begin{matrix}{x}_{0} \\ {x}_{1} \\ {x}_{2} \\ {x}_{3} \\ {x}_{4} \\ ⋮ \\ {x}_{2 {i}_{m} + 1} \\ {x}_{2 {i}_{m} + 2}\end{matrix} ] ,$$

$${y}_{[ - T , 0 ]} = [ \begin{matrix}{x}_{0 - T} \\ {x}_{1 - T} \\ {x}_{2 - T} \\ {x}_{3 - T} \\ {x}_{4 - T} \\ ⋮ \\ {x}_{2 {i}_{m} + 1 - T} \\ {x}_{2 {i}_{m} + 2 - T}\end{matrix} ] ,$$

$${z}_{[ 0 , T ]} = {\sum }_{k = 1}^{N} {\sum }_{j = 1}^{{N}_{a}} [ \begin{matrix}0 \\ {S}_{0} + {S}_{1 / 2} + {S}_{1} \\ {T}_{0} + {T}_{1} + {T}_{2} \\ {S}_{2} + {S}_{2 + 1 / 2} + {S}_{3} \\ {T}_{2} + {T}_{3} + {T}_{4} \\ ⋮ \\ {S}_{2 {i}_{m}} + {S}_{2 {i}_{m} + 1 / 2} + {S}_{2 {i}_{m} + 1} \\ {T}_{2 {i}_{m}} + {T}_{2 {i}_{m} + 1} + {T}_{2 {i}_{m} + 2}\end{matrix} ] ,$$

$${P}_{1} = [ \begin{matrix}I & 0 & 0 & 0 & 0 & ⋯ & 0 & 0 & 0 \\ {F}_{0} & {F}_{1} & {F}_{2} & 0 & 0 & ⋯ & 0 & 0 & 0 \\ {G}_{0} & {G}_{1} & {G}_{2} & 0 & 0 & ⋯ & 0 & 0 & 0 \\ 0 & 0 & {F}_{2} & {F}_{3} & {F}_{4} & ⋯ & 0 & 0 & 0 \\ 0 & 0 & {G}_{2} & {G}_{3} & {G}_{4} & ⋯ & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & ⋯ & {F}_{2 {i}_{m}} & {F}_{2 {i}_{m} + 1} & {F}_{2 {i}_{m} + 2} \\ 0 & 0 & 0 & 0 & 0 & ⋯ & {G}_{2 {i}_{m}} & {G}_{2 {i}_{m} + 1} & {G}_{2 {i}_{m} + 2}\end{matrix} ] ,$$

$$Q = {\sum }_{k = 1}^{N} {\sum }_{j = 1}^{{N}_{a}} [ \begin{matrix}0 & ⋯ & 0 & 0 & 0 & ⋯ & 0 & 0 & I / {NN}_{a} \\ 0 & ⋯ & {F}_{- τ ( j , k , p )} & {F}_{1 - τ ( j , k , p )} & {F}_{2 - τ ( j , k , p )} & ⋯ & 0 & 0 & 0 \\ 0 & ⋯ & {G}_{- τ ( j , k , p )} & {G}_{1 - τ ( j , k , p )} & {G}_{2 - τ ( j , k , p )} & ⋱ & ⋮ & 0 & 0 \\ ⋮ & ⋱ & ⋮ & ⋮ & ⋮ & ⋱ & ⋮ & ⋮ & ⋮ \\ 0 & ⋯ & 0 & 0 & 0 & ⋯ & {F}_{2 i - τ ( j , k , p )} & {F}_{2 i + 1 - τ ( j , k , p )} & {F}_{2 i + 2 - τ ( j , k , p )} \\ 0 & ⋯ & 0 & 0 & 0 & ⋯ & {G}_{2 i - τ ( j , k , p )} & {G}_{2 i + 1 - τ ( j , k , p )} & {G}_{2 i + 2 - τ ( j , k , p )} \\ ⋮ & ⋱ & ⋮ & ⋮ & ⋮ & ⋱ & ⋮ & ⋮ & ⋮ \\ 0 & ⋯ & 0 & 0 & 0 & ⋯ & 0 & 0 & 0\end{matrix} ]$$

$$and$$

$${P}_{2} = {\sum }_{k = 1}^{N} {\sum }_{j = 1}^{{N}_{a}} [ \begin{matrix}0 & 0 & 0 & ⋯ & 0 & 0 & 0 & ⋯ & 0 \\ ⋮ & ⋮ & ⋮ & ⋱ & ⋮ & ⋮ & ⋮ & ⋯ & 0 \\ {F}_{2 i + 2 - τ ( j , k , p )} & {F}_{2 i + 3 - τ ( j , k , p )} & {F}_{2 i + 4 - τ ( j , k , p )} & ⋯ & 0 & 0 & 0 & ⋯ & 0 \\ {G}_{2 i + 2 - τ ( j , k , p )} & {G}_{2 i + 3 - τ ( j , k , p )} & {G}_{2 i + 4 - τ ( j , k , p )} & ⋱ & 0 & 0 & 0 & ⋯ & 0 \\ 0 & 0 & ⋮ & ⋱ & 0 & 0 & 0 & ⋯ & 0 \\ ⋮ & ⋮ & ⋮ & ⋮ & ⋮ & ⋮ & ⋮ & ⋮ & ⋮ \\ 0 & 0 & 0 & ⋯ & {F}_{2 {i}_{m} - τ ( j , k , p )} & {F}_{2 {i}_{m} + 1 - τ ( j , k , p )} & {F}_{2 {i}_{m} + 2 - τ ( j , k , p )} & ⋯ & 0 \\ 0 & 0 & 0 & ⋯ & {G}_{2 {i}_{m} - τ ( j , k , p )} & {G}_{2 {i}_{m} + 1 - τ ( j , k , p )} & {G}_{2 {i}_{m} + 2 - τ ( j , k , p )} & ⋯ & 0\end{matrix} ] .$$

The step 3 is:

construct transition matrix Φ of the milling system:

$$Φ = \{ \begin{matrix}{( {P}_{1} - {P}_{2} )}^{- 1} Q , & if \vert {P}_{1} - {P}_{2} \vert \neq 0 \\ {( {P}_{1} - {P}_{2} )}^{†} Q , & if \vert {P}_{1} - {P}_{2} \vert = 0\end{matrix}$$

where |P₁−P₂| denotes determinant of matrix (P₁−P₂); † denotes Moore-Penrose pseudoinverse of matrix (P₁−P₂); based on Floquet theory, stability of milling system depends on eigenvalue of Φ: it is stable if all modules of eigenvalues of Φ are less than 1; it is unstable otherwise.

The step 4 is:

based on fixed mapping point theorem, the state variable vector x(t) satisfies x(tᵢ)=x(tᵢ−T) for chatter-free cutting conditions; therefore, it has y_{[0,T]}=y_{[-T,0]}; state variables on all discrete points are calculated by:

$${y}^{*} = {y}_{[ 0 , T ]} = {y}_{[ - T , 0 ]} = \{ \begin{matrix}{( {P}_{1} - {P}_{2} - Q )}^{- 1} {z}_{[ 0 , T ]} , & if \vert {P}_{1} - {P}_{2} - Q \vert \neq 0 \\ {( {P}_{1} - {P}_{2} - Q )}^{†} {z}_{[ 0 , T ]} , & if \vert {P}_{1} - {P}_{2} - Q \vert = 0\end{matrix}$$

where y* consists of modal displacement vector Γ(tᵢ) and modal velocity vector \dot{Γ}(tᵢ) at all discrete time nodes i=0,1, . . . ,2iₘ+2 during one rotation period of cutting tool.

The step 5 comprises sub-steps of:

step 5.1: transform modal displacements into physical space, and calculate relative vibration displacements q(tᵢ) between cutting tool and workpiece:

q(tᵢ)=q_{T}(tᵢ)−q_{W}(tᵢ)=P_{T}Γ_{T}(tᵢ)−P_{W}Γ_{W}(tᵢ)

where q_{T} (tᵢ) and q_{W}(tᵢ) are vibration displacements of cutting tool and workpiece, respectively;

step 5.2: extract vibration displacements in direction normal to milled surface of workpiece (defined as \vec{Oy} direction) from q(tᵢ), which constructs a new vector Q_{y}*:

Q_{y}*={[q_{y}(t₁)]^{T},[q_{y}(t₂)]^{T}, . . . ,[q_{y}(t₂ᵢ_{ₘ}₊₂)]^{T}}

extract vibration displacements in feed direction (defined as \vec{Ox} direction), which constructs a new vector Qₓ*:

Qₓ*:={[qₓ(t₁)]^{T},[qₓ(t₂)]^{T}, . . . ,[qₓ(t₂ᵢ_{ₘ}₊₂)]^{T}}

step 5.3: based on kinematic synthesis of relative feed movement between cutting tool and workpiece, rotation of cutting tool and relative vibrations between cutting tool and workpiece, calculate motion trajectories in \vec{Oy} direction and \vec{Ox} direction for cutting element (j,k), respectively:

$${Θ}_{y}^{⋆} ( i , j , k ) = {\underbrace{\frac{f \cdot {t}_{i}}{1000 \times 60} sin ( {φ}_{fy} )}}_{feed} - {\underbrace{R ( j , k ) cos ( {φ}_{ref} - ϕ ( j , k ) - \frac{{z}_{j} tan ( {β}_{k} )}{R} + 2 π \frac{Ω {t}_{i}}{60} )}}_{rotation} + {\underbrace{{Q}_{y}^{*} ( i , j )}}_{vibration}$$

$${Θ}_{x}^{⋆} ( j , k , i ) = {\underbrace{\frac{f \cdot {t}_{i}}{1000 \times 60} cos ( {φ}_{fy} )}}_{feed} + {\underbrace{R ( j , k ) sin ( {φ}_{ref} - ϕ ( j , k ) - \frac{{z}_{j} tan ( {β}_{k} )}{R} + \frac{60 {t}_{i}}{Ω} )}}_{rotation} + {\underbrace{{Q}_{x}^{*} ( j , i )}}_{vibrations}$$

where f is relative feed rate between cutting tool and workpiece in mm/min; φ_{fy} is angle between feed direction of cutting tool and normal direction of workpiece; R(j,k) is actual cutting radius of cutting element (j,k); φ_{ref} is reference angle used in the Generalized Runge-Kutta method; φ(j,k) is pitch angle between Tooth k and Tooth 1 for j-th discrete axial slice; βₖ is helix angle with regard to Tooth k; zⱼ is axial height of j-th discrete axial slice; R is geometric radius of cutting tool; Ω is spindle rotation speed; Q_{y}*(j,i) and Qₓ*(j,i) are vibration displacements of cutting element (j,k) in \vec{Oy} and \vec{Ox} directions, respectively.

The step 6 comprises sub-steps of:

step 6.1: select part of motion trajectories of cutting tool that are near milled surface of workpiece based on following equation, which construct motion trajectory points to be densified with interpolation, i.e., (Θ_{x_trim}*(j,k,i), ι_{y_trim}*(j,k,i)):

Θ_{y}*(j,k,i)≥max{Θ_{y}*(j,k,i)}−αR, down-milling

Θ_{y}*(j,k,i)≤min{Θ_{y}*(j,k,i)}+αR,up-milling

where α is a coefficient to adjust selecting range;

step 6.2: determine lower and upper limits of the selected trajectory points in \vec{Ox} direction, i.e., xₘᵢₙ=min {Θ_{x_trim}*(j,k,i)} and xₘₐₓ=max {Θ_{x_trim}*(j,k,i)}; discretize interval [xₘᵢₙ,xₘₐₓ] equally with a step δx to obtain x coordinate set of interpolation points {xₘᵢₙ, xₘᵢₙ+δx, xₘᵢₙ+2·δx, . . . , xₘₐₓ}, where number of points is denoted by Nₛ;

step 6.3: taking the selected points (Θ_{x_trim}*(j,k,i),Θ_{y_trim}*(j,k,i)) in step 6.1 as known points, use spline interpolation algorithm to determine y coordinates of interpolation points with regard to x coordinates {xₘᵢₙ, xₘᵢₙ+δx,xₘᵢₙ+2·δx, . . . ,xₘₐₓ}, which results in densified motion trajectories of cutting tool edges during one rotation period T of cutting tool, i.e., (xₛ(l), yₛ(l)),l=1, 2, . . . Nₛ;

step 6.4: based on periodicity of chatter-free milling dynamic responses, i.e., xₛ(l) and xₛ(l)+nᵣₑᵥT share same y coordinate yₛ(l), obtain densified motion trajectory points of cutting tool during nᵣₑᵥ, rotation periods of cutting tool, i.e., (x_{s_n}(l), y_{s_n}(l)), l=1,2, . . . N_{s_n}, where N_{s_n} is number of interpolation points on nᵣₑᵥ rotation periods of cutting tool, and nᵣₑᵥ≥4;

step 6.5: select densified motion trajectory points of cutting tool edges on middle periods that satisfy xₘᵢₙ+T≤x_{s_n}(l)≤nᵣₑᵥ·xₘₐₓ−T to construct a new densified point set (x_{s_n_trim}(l), y_{s_n_trim}(l)), l=1,2, . . . N_{s_n_trim}, where N_{s_n_trim} is number of trimmed interpolation points;

step 6.6: sort the selected set (x_{s_n_trim}(l), y_{s_n_trim}(l)) in order of axial height to construct Nₐ sub-sets of densified points, i.e., (x_{s_n_trim},(j,l), y_{s_n_trim}(j,l)), j=1, 2, . . . ,Nₐ;

step 6.7: at each axial height, compare values of y coordinates for all teeth that have same x coordinate; based on following equation, select densified points that are nearest to milled surface of workpiece to construct final surface topography points of workpiece (x_{surf}(j,l), y_{surf}(j,l)), l=1, 2, . . . N_{s_n_trim}:

$${y}_{surf} ( j , l ) = {max}_{k} \{ {y}_{s \_ n \_ trim} ( j , l ) \} , \qquad down - milling$$

$${y}_{surf} ( j , l ) = {min}_{k} \{ {y}_{s \_ n \_ trim} ( j , l ) \} , \qquad up - milling$$

The step 7 is:

calculate surface location error (SLE) based on motion trajectories Θ_{y}*(i,j,k) in normal direction of workpiece; surface location error SLE(j,k) with regard to cutting element (j,k) is:

$$S L E ( j , k ) = \{ \begin{matrix}{max}_{i} \{ {Θ}_{y}^{*} ( j , k , i ) \vert 1 \leq i \leq 2 {i}_{m} + 2 \} - D / 2 , & down - milling \\ - {min}_{i , k} \{ {Θ}_{y}^{*} ( j , k , i ) \vert 1 \leq i \leq 2 {i}_{m} + 2 \} - D / 2 , & up ‐ milling\end{matrix}$$

surface location error with regard to axial height zⱼ is:

$$S L E ( j ) = \{ \begin{matrix}{max}_{i , k} \{ {Θ}_{y}^{*} ( j , k , i ) \vert 1 \leq i \leq 2 {i}_{m} + 2 , 1 \leq k \leq N \} - D / 2 , & down - milling \\ - {min}_{i , k} \{ {Θ}_{y}^{*} ( j , k , i ) \vert 1 \leq i \leq 2 {i}_{m} + 2 , 1 \leq k \leq N \} - D / 2 , & up ‐ milling\end{matrix}$$

where positive value mean overcut, and negative value mean undercut.

The step 8 is:

based on points (x_{surf}(j,l), y_{surf}(j,l)) that participate in generating surface topography of workpiece, surface roughness is calculated by:

$$R a ( j ) = \frac{1}{{N}_{s \_ n \_ trim}} {\sum }_{{i}^{′} = 1}^{{N}_{s \_ n \_ trim}} \vert {y}_{surf} ( j , l ) - {\overline{y}}_{surf} ( j , l ) \vert$$

By comparison with existing techniques, the invention has following advantages:

1. The invention discloses a method for simulating chatter-free milled surface topography. By comparison with initial value based time-domain simulation method, the invented method significantly improves the computational efficiency for simulating chatter-free milled surface topography;

2. The invention can simultaneously predict milling stability, surface location error and surface roughness, which provides theoretical and technical guidance for avoidance of milling chatter, improvement of cutting efficiency and assurance of machining quality.

### BRIEF DESCRIPTION OF DRAWINGS

Other features, objects and advantages of the present invention will become apparent upon reading following detailed description of unrestricted examples, while referring to attached drawings in which:

FIGS. 1(a) to 1(d) are a flow diagram representing simulation procedure of milled surface topography of workpiece, where FIG. 1(a) represents motion trajectories of cutting tool edges, FIG. 1(b) represents densified motion trajectories of cutting tool using spline interpolation for each tooth during one rotation period of cutting tool, FIG. 1(c) represents densified motion trajectories of cutting tool during several rotation periods of cutting tool, and FIG. 1(d) represents the final surface topography of workpiece, which is determined by comparing motion trajectories of cutting tool edges for different teeth.

FIGS. 2(a) to 2(b) are comparison between experimental surface topography and simulated results; FIG. 2(a) is microphotograph of milled surface topography, and FIG. 2(b) is simulated milled surface topography.

FIG. 3 is comparison between simulated and measured surface location errors along tool axial height.

FIG. 4 is simulated surface roughness value along tool axial height.

### EXAMPLES

The present invention will be described in detail below in conjunction with specific embodiments. The following examples will help those skilled in the art to further understand the present invention, but do not limit the present invention in any way. It should be pointed out that for those of ordinary skill in the art, several modifications and improvements can be made without departing from the concept of the present invention. These all belong to the protection scope of the present invention.

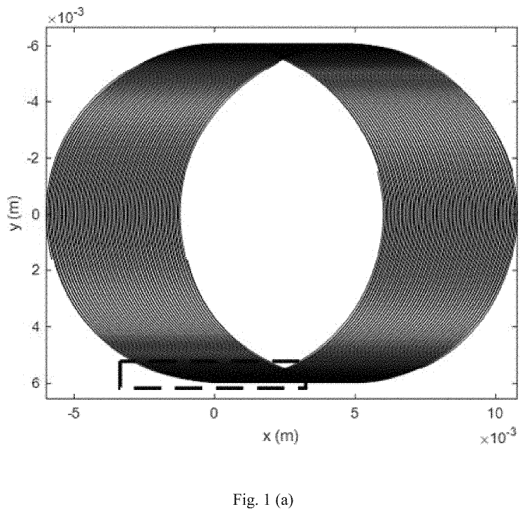

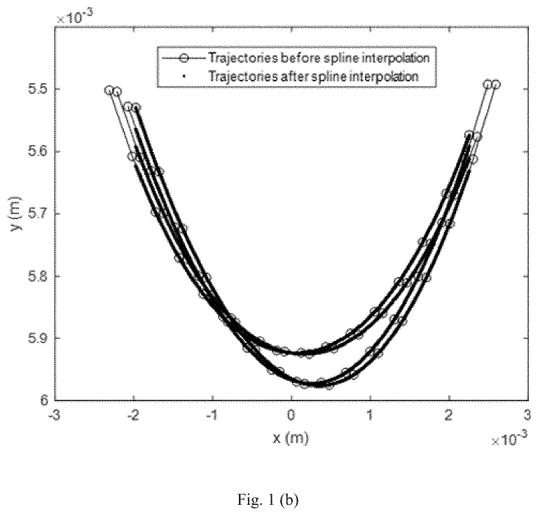

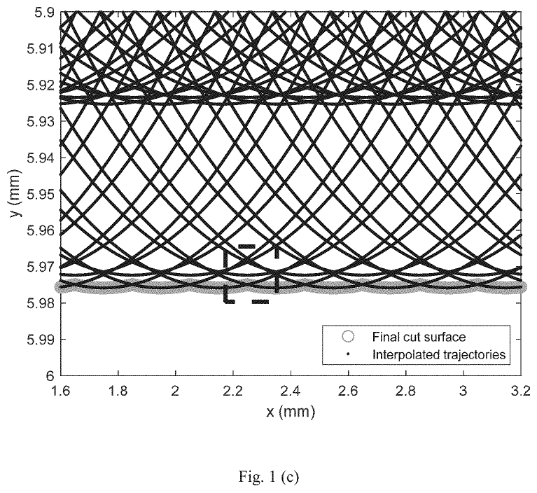

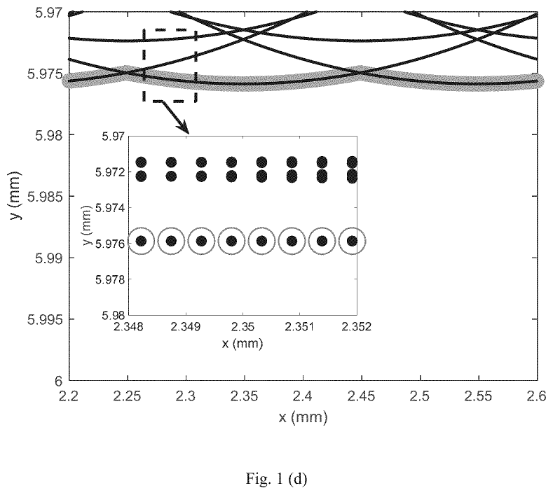

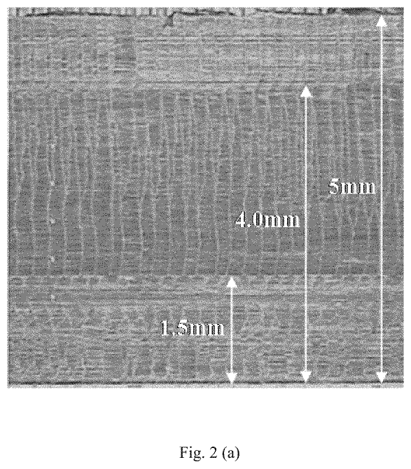

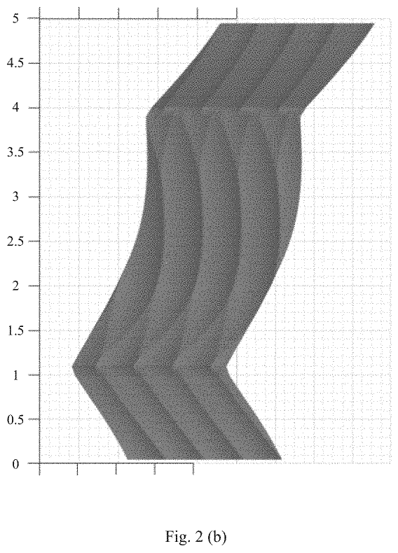

Refer to FIG. 1(a), FIG. 1(b), FIG. 1(c), FIG. 1(d), FIG. 2(a) and FIG. 2(b).

This example provides a method for simulating chatter-free milled surface topography, comprising steps of:

Step 1 comprises sub-steps of:

step 1.1: considering flexibility of both cutting tool and workpiece, variance of pitch angles and helix angles of cutting tool, and teeth runout, perform dynamics modeling on milling system and build a delay differential equation with multiple delays to represent the dynamic model in physical space:

$$M \ddot{q} ( t ) + C \dot{q} ( t ) + K q ( t ) = {\sum }_{k = 1}^{N} {\sum }_{j = 1}^{{N}_{a}} \{ {K}_{c} ( t , j , k ) [ q ( t ) - q ( t - {\sum }_{p = {k}_{v}}^{k} τ ( j , p ) ) ] + {F}_{0} ( t , j , k ) \} \qquad ( 1 )$$

where M, C and K are mass, damping and stiffness matrices, respectively; \ddot{q}(t) \dot{q}(t) and q(t) are acceleration, velocity and displacement vectors at time t, respectively; K_{c}(t,j,k) is directional coefficient matrix for Tooth k at j-th axial slice at time t; F₀(t,j,k) is cutting force vector for Tooth k at j-th axial slice at time t, which is independent of chip regeneration; Σₚ₌ₖ_{ᵥ}^{k}τ(j,p) is time delay with regard to cutting element (j,k), Σ is mathematical summation operator, p is a variable for summation, and kᵥ is tooth serial number to start delay calculation; N is number of teeth; and Nₐ is number of axial discretization of tool;

step 1.2: perform modal coordinate transformation on the dynamic model in step 1.1, which can be transformed from physical space into modal space; the modal coordinate transformation equation is:

q(t)=PΓ(t) (2)

where P is the mode shape matrix, and Γ(t) is the modal displacement at time t;

dynamics model in modal space which is represented with delay differential equation with multiple delays turns out to be:

$${M}_{Γ} \ddot{Γ} ( t ) + {C}_{Γ} \dot{Γ} ( t ) + {K}_{Γ} Γ ( t ) = {\sum }_{k = 1}^{N} {\sum }_{j = 1}^{{N}_{a}} \{ {P}^{T} {K}_{c} ( t , j , k ) P [ Γ ( t ) - Γ ( t - {\sum }_{p = {k}_{v}}^{k} τ ( j , p ) ) ] + {P}^{T} {F}_{0} ( t , j , k ) \} \qquad ( 3 )$$

where M_{Γ}, C_{Γ} and K_{Γ} are modal mass, modal damping and modal stiffness matrices, respectively; \ddot{Γ}(t), \dot{Γ}(t) and Γ(t) are modal acceleration, modal velocity and modal displacement vectors, respectively;

for milling system with flexible cutting tool and flexible workpiece, the dynamic model becomes:

$$[ \begin{matrix}{M}_{Γ ; T} & \\ & {M}_{Γ ; W}\end{matrix} ] \{ \begin{matrix}{\ddot{Γ}}_{T} ( t ) \\ {\ddot{Γ}}_{W} ( t )\end{matrix} \} + [ \begin{matrix}{C}_{Γ ; T} & \\ & {C}_{Γ ; W}\end{matrix} ] \{ \begin{matrix}{\dot{Γ}}_{T} ( t ) \\ {\dot{Γ}}_{W} ( t )\end{matrix} \} + [ \begin{matrix}{K}_{Γ ; T} & \\ & {K}_{Γ ; W}\end{matrix} ] \{ \begin{matrix}{Γ}_{T} ( t ) \\ {Γ}_{W} ( t )\end{matrix} \} = {\sum }_{k = 1}^{N} {\sum }_{j = 1}^{{N}_{a}} \{ [ \begin{matrix}{P}_{T}^{T} \\ - {P}_{W}^{T}\end{matrix} ] {K}_{c} ( t , j , k ) [ \begin{matrix}{P}_{T} & - {P}_{W}\end{matrix} ] \{ \begin{matrix}{Γ}_{T} ( t ) - {Γ}_{T} ( {\sum }_{p = {k}_{v}}^{k} τ ( j , p ) ) \\ {Γ}_{W} ( t ) - {Γ}_{W} ( {\sum }_{p = {k}_{v}}^{k} τ ( j , p ) )\end{matrix} \} + [ \begin{matrix}{P}_{T}^{T} \\ - {P}_{W}^{T}\end{matrix} ] {F}_{0} ( t , j , k ) \} \qquad ( 4 )$$

where M_{Γ,T}, C_{Γ,T} and K_{Γ,T} are modal mass, modal damping and modal stiffness matrices of cutting tool; M_{Γ;W}, C_{Γ;W} and K_{Γ;W} are modal mass, modal damping and modal stiffness matrices of workpiece; \ddot{Γ}_{T}(t), \dot{Γ}_{T}(t) and Γ_{T}(t) are modal acceleration, modal velocity and modal displacement vectors of cutting tool; \ddot{Γ}_{W}(t), \dot{Γ}_{W}(t) and Γ_{W}(t) are modal acceleration, modal velocity and modal displacement vectors of workpiece; P_{T} and P_{W} are mode shape matrices of cutting tool and workpiece, respectively; P_{T}^{T} and P_{W}^{T} are transposed matrices of P_{T} and P_{W}, respectively;

for milling system with flexible cutting tool and rigid workpiece, the dynamic model becomes:

$${M}_{Γ ; T} {\ddot{Γ}}_{T} ( t ) + {C}_{Γ ; T} {\dot{Γ}}_{T} ( t ) + {K}_{Γ ; T} {Γ}_{T} ( t ) = {\sum }_{k = 1}^{N} {\sum }_{j = 1}^{{N}_{a}} \{ {P}_{T}^{T} {K}_{c} ( t , j , k ) \{ {P}_{T} [ {Γ}_{T} ( t ) - {Γ}_{T} ( t - {\sum }_{p = {k}_{v}}^{k} τ ( j , p ) ) ] \} + {P}_{T}^{T} {F}_{0} ( t , j , k ) \} \qquad ( 5 )$$

for milling system with rigid cutting tool and flexible workpiece, the dynamic model becomes:

$${M}_{Γ ; W} {\ddot{Γ}}_{W} ( t ) + {C}_{Γ ; W} {\dot{Γ}}_{W} ( t ) + {K}_{Γ ; W} {Γ}_{W} ( t ) = {\sum }_{k = 1}^{N} {\sum }_{j = 1}^{{N}_{a}} \{ {P}_{W}^{T} {K}_{c} ( t , j , k ) \{ {P}_{W} [ {Γ}_{W} ( t ) - {Γ}_{W} ( t - {\sum }_{p = {k}_{v}}^{k} τ ( j , p ) ) ] \} - {P}_{W}^{T} {F}_{0} ( t , j , k ) \} \qquad ( 6 )$$

Step 2 comprises sub-steps of:

step 2.1: perform state space transformation on the dynamic model in modal space by introducing state variable vector x(t)=[(Γ(t))^{T}, (\dot{Γ}(t))^{T}]^{T}, and delay differential equation with multiple delays in state space becomes:

$$\dot{x} ( t ) = A x ( t ) + {\sum }_{k = 1}^{N} {\sum }_{j = 1}^{{N}_{a}} \{ B ( t , j , k ) [ x ( t ) - x ( t - {\sum }_{p = {k}_{v}}^{k} τ ( j , p ) ) ] + D ( t , j , k ) \} \qquad ( 7 )$$

where x(t) denotes state variable vector, \dot{x}(t) denotes first derivative of x(t) with regard to time t,

$$A = [ \begin{matrix}0 & I \\ - {M}_{Γ}^{- 1} {K}_{Γ} & - {M}_{Γ}^{- 1} {C}_{Γ}\end{matrix} ] ,$$

$$B ( t , j , k ) = [ \begin{matrix}0 & 0 \\ {M}_{Γ}^{- 1} {P}^{T} {K}_{c} ( t , j , k ) P & 0\end{matrix} ] ,$$

$$D ( t , j , k ) = [ \begin{matrix}0 \\ {M}_{Γ}^{- 1} {P}^{T} {F}_{0} ( t , j , k )\end{matrix} ] ,$$

and I is unit matrix;

step 2.2: divide one rotation period of cutting tool T into 2iₘ+2 equal intervals with a series of discrete nodes {t₀,t₁, . . . ,t₂ᵢ_{ₘ}₊₂}; analytical expression of dynamic responses at interval [tᵢ,t] with regard to the delay differential equation with multiple delays in step 2.1 is:

$$x ( t ) = {e}^{A ( t - {t}_{i} )} x ( {t}_{i} ) + {\sum }_{k = 1}^{N} {\sum }_{j = 1}^{{N}_{a}} {\int }_{{t}_{i}}^{t} \{ {e}^{A ( t - ξ )} B ( ξ , j , k ) [ x ( ξ ) - x ( ξ - {\sum }_{p = {k}_{v}}^{k} τ ( j , p ) ) ] + {e}^{A ( t - ξ )} D ( ξ , j , k ) \} d ξ . \qquad ( 8 )$$

for brevity, define xᵢ:=x(tᵢ), E(t,tᵢ):=e^{A(t-t}^{ᵢ}⁾x(tᵢ), H_{j,k}(t,ξ,x(ξ)):=e^{A(t-ξ)}B(ξ, j,k)[x(ξ)−x(ξ−τ(j,k, p))] and J_{j,k}(t,ξ):=e^{A(t-ξ)}D(ξ,j, j,k);

on sub-interval [t₂ᵢ,t₂ᵢ₊₂], x(t) is approximated using Simpson's rule:

$${x}_{2 i + 2} = E ( {t}_{2 i + 2} , {t}_{2 i} ) + \frac{h}{3} {\sum }_{k = 1}^{N} {\sum }_{j = 1}^{{N}_{a}} \{ {H}_{j , k} ( {t}_{2 i + 2} , {t}_{2 i} , {x}_{2 i} ) + 4 {H}_{j , k} ( {t}_{2 i + 2} , {t}_{2 i + 1} , {x}_{2 i + 1} ) + {H}_{j , k} ( {t}_{2 i + 2} , {t}_{2 i + 2} , {x}_{2 i + 2} ) + {J}_{j , k} ( {t}_{2 i + 2} , {t}_{2 i} ) + 4 {J}_{j , k} ( {t}_{2 i + 2} , {t}_{2 i + 1} ) + {J}_{j , k} ( {t}_{2 i + 2} , {t}_{2 i + 2} ) \} \qquad ( 9 )$$

on sub-interval [t₂ᵢ,t₂ᵢ₊₁], x(t) is approximated using fourth-order Runge-Kutta algorithm:

$${x}_{2 i + 1} = E ( {t}_{2 i + 1} , {t}_{2 i} ) + \frac{h}{6} {\sum }_{k = 1}^{N} {\sum }_{j = 1}^{{N}_{a}} \{ {H}_{j , k} ( {t}_{2 i + 1} , {t}_{2 i} , {x}_{2 i} ) + 2 {H}_{j , k} ( {t}_{2 i + 1} , {t}_{2 i + 1 / 2} , {x}_{2 i + 1 / 2} ) + 2 {H}_{j , k} ( {t}_{2 i + 1} , {t}_{2 i + 1 / 2} , {x}_{2 i + 1 / 2} ) + {H}_{j , k} ( {t}_{2 i + 1} , {t}_{2 i + 1} , {x}_{2 i + 1} ) + {J}_{j , k} ( {t}_{2 i + 1} , {t}_{2 i} ) + 2 {J}_{j , k} ( {t}_{2 i + 1} , {t}_{2 i + 1 / 2} ) + 2 {J}_{j , k} ( {t}_{2 i + 1} , {t}_{2 i + 1 / 2} ) + {J}_{j , k} ( {t}_{2 i + 1} , {t}_{2 i + 1} ) \} \qquad ( 10 )$$

where state variable vector at middle points t_{2i+1/2} is approximated with Lagrange formula:

x_{2i+1/2}=⅜x₂ᵢ−¾x₂ᵢ₋₁+⅛x₂ᵢ₊₂ (11)

the analytical expression of dynamic responses on sub-interval [t₂ᵢ,t₂ᵢ₊₁] is re-organized into:

$$\begin{matrix}{F}_{2 i} {x}_{2 i} + {F}_{2 i + 1} {x}_{2 i + 1} + {F}_{2 i + 2} {x}_{2 i + 2} = \\ {\sum }_{k = 1}^{N} {\sum }_{j = 1}^{{N}_{a}} ( {F}_{2 i - τ ( j , k )} {x}_{2 i - τ ( j , k )} + {F}_{2 i + 1 - τ ( j , k )} {x}_{2 i + 1 - τ ( j , k )} + {F}_{2 i + 2 - τ ( j , k )} {x}_{2 i + 2 - τ ( j , k )} ) + {\sum }_{k = 1}^{N} {\sum }_{j = 1}^{{N}_{a}} ( {S}_{2 i} + {S}_{2 i + 1 / 2} + {S}_{2 i + 1} ) \\ where \\ {F}_{2 i} = - {e}^{A h} - \frac{h}{6} {e}^{A h} {\sum }_{k = 1}^{N} {\sum }_{j = 1}^{{N}_{a}} {B}_{2 i , j , k} - \frac{3}{8} \cdot \frac{4 h}{6} {e}^{A h / 2} {\sum }_{k = 1}^{N} {\sum }_{j = 1}^{{N}_{a}} {B}_{2 i + 1 / 2 , j , k} , \\ {F}_{2 i + 1} = I - \frac{3}{4} \cdot \frac{4 h}{6} {e}^{A h / 2} {\sum }_{k = 1}^{N} {\sum }_{j = 1}^{{N}_{a}} {B}_{2 i + 1 / 2 , j , k} - \frac{h}{6} {\sum }_{k = 1}^{N} {\sum }_{j = 1}^{{N}_{a}} {B}_{2 i + 1 , j , k} , {F}_{2 i + 2} = \frac{1}{8} \cdot \frac{4 h}{6} {e}^{A h / 2} {\sum }_{k = 1}^{N} {\sum }_{j = 1}^{{N}_{a}} {B}_{2 i + 1 / 2 , j , k} , \\ {F}_{2 i - τ ( j , k , p )} = - \frac{h}{6} {e}^{A h} {B}_{2 i , j , k} - \frac{3}{8} \cdot \frac{4 h}{6} {e}^{A h / 2} {B}_{2 i + 1 / 2 , j , k} , {F}_{2 i + 1 - τ ( j , k , p )} = - \frac{3}{4} \cdot \frac{4 h}{6} {e}^{A h / 2} {B}_{2 i + 1 / 2 , j , k} - \frac{h}{6} {B}_{2 i + 1 , j , k} , \\ {F}_{2 i + 2 - τ ( j , k , p )} = \frac{1}{8} \cdot \frac{4 h}{6} {e}^{A h / 2} {B}_{2 i + 1 / 2 , j , k} , {S}_{2 i} = \frac{h}{6} {e}^{A \cdot h} {D}_{2 i , j , k} , {S}_{2 i + 1 / 2} = \frac{h}{6} \cdot 4 {e}^{A \cdot h / 2} {D}_{2 i + 1 / 2 , j , k} , {S}_{2 i + 1} = \frac{h}{6} {D}_{2 i + 1 , j , k} ,\end{matrix} \qquad ( 12 )$$

and h is discretization step;

the analytical expression of dynamic responses on sub-interval [t₂ᵢ,t₂ᵢ₊₂] is re-organized into:

$$\begin{matrix}{G}_{2 i} {x}_{2 i} + {G}_{2 i + 1} {x}_{2 i + 1} + {G}_{2 i + 2} {x}_{2 i + 2} = \\ {\sum }_{k = 1}^{N} {\sum }_{j = 1}^{{N}_{a}} ( {G}_{2 i - τ ( j , k )} {x}_{2 i - τ ( j , k )} + {G}_{2 i + 1 - τ ( j , k )} {x}_{2 i + 1 - τ ( j , k )} + {G}_{2 i + 2 - τ ( j , k )} {x}_{2 i + 2 - τ ( j , k )} ) + {\sum }_{k = 1}^{N} {\sum }_{j = 1}^{{N}_{a}} ( {T}_{2 i} + {T}_{2 i + 1} + {T}_{2 i + 2} ) \\ where \\ {G}_{2 i} = - {e}^{2 A h} - \frac{h}{3} {e}^{2 A h} {\sum }_{k = 1}^{N} {\sum }_{j = 1}^{{N}_{a}} {B}_{2 i , j , k} , {G}_{2 i + 1} = - \frac{4 h}{3} {e}^{A h} {\sum }_{k = 1}^{N} {\sum }_{j = 1}^{{N}_{a}} {B}_{2 i + 1 , j , k} , \\ {G}_{2 i + 2} = I - \frac{h}{3} {\sum }_{k = 1}^{N} {\sum }_{j = 1}^{{N}_{a}} {B}_{2 i + 2 , j , k} , {G}_{2 i - τ ( j , k , p )} = - \frac{h}{3} {e}^{2 A h} {B}_{2 i , j , k} , {G}_{2 i + 1 - τ ( j , k , p )} = - \frac{4 h}{3} {e}^{Ah} {B}_{2 i + 1 , j , k} , \\ {G}_{2 i + 2 - τ ( j , k , p )} = - \frac{h}{3} {B}_{2 i + 2 , j , k} , {T}_{2 i} = \frac{h}{3} {e}^{A \cdot 2 h} {D}_{2 i , j , k} , {T}_{2 i + 1} = \frac{h}{3} \cdot 4 {e}^{A \cdot h} {D}_{2 i + 1 , j , k} and {T}_{2 i + 2} = \frac{h}{3} {D}_{2 i + 2 , j , k} ;\end{matrix} \qquad ( 13 )$$

step 2.3: based on the formulae in step 2.2, discrete mapping relationship between two adjacent rotation periods of cutting tool [−T,0] and [0,T] is established:

P₁y_{[0,T]}=Qy_{[-T,0]}+P₂y_{[0,T]}+z_{[0,T]} (14)

where

$$\begin{matrix}{y}_{[ 0 , T ]} = [ \begin{matrix}{x}_{0} \\ {x}_{1} \\ {x}_{2} \\ {x}_{3} \\ {x}_{4} \\ ⋮ \\ {x}_{2 {i}_{m} + 1} \\ {x}_{2 {i}_{m} + 2}\end{matrix} ] , {y}_{[ - T , 0 ] =} [ \begin{matrix}{x}_{0 - T} \\ {x}_{1 - T} \\ {x}_{2 - T} \\ {x}_{3 - T} \\ {x}_{4 - T} \\ ⋮ \\ {x}_{2 {i}_{m} + 1 - T} \\ {x}_{2 {i}_{m} + 2 - T}\end{matrix} ] , {z}_{[ 0 , T ]} = {\sum }_{k = 1}^{N} {\sum }_{j = 1}^{{N}_{a}} [ \begin{matrix}0 \\ {S}_{0} + {S}_{1 / 2} + {S}_{1} \\ {T}_{0} + {T}_{1} + {T}_{2} \\ {S}_{2} + {S}_{2 + 1 / 2} + {S}_{3} \\ {T}_{2} + {T}_{3} + {T}_{4} \\ ⋮ \\ {S}_{2 {i}_{m}} + {S}_{2 {i}_{m} + 1 / 2} + {S}_{2 {i}_{m} + 1} \\ {T}_{2 {i}_{m}} + {T}_{2 {i}_{m} + 1} + {T}_{2 {i}_{m} + 2}\end{matrix} ] , \\ {P}_{1} = [ \begin{matrix}I & 0 & 0 & 0 & 0 & … & 0 & 0 & 0 \\ {F}_{0} & {F}_{1} & {F}_{2} & 0 & 0 & … & 0 & 0 & 0 \\ {G}_{0} & {G}_{1} & {G}_{2} & 0 & 0 & … & 0 & 0 & 0 \\ 0 & 0 & {F}_{2} & {F}_{3} & {F}_{4} & … & 0 & 0 & 0 \\ 0 & 0 & {G}_{2} & {G}_{3} & {G}_{4} & … & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & … & {F}_{2 {i}_{m}} & {F}_{2 {i}_{m} + 1} & {F}_{2 {i}_{m} + 2} \\ 0 & 0 & 0 & 0 & 0 & … & {G}_{2 {i}_{m}} & {G}_{2 {i}_{m} + 1} & {G}_{2 {i}_{m} + 2}\end{matrix} ] , \\ Q = {\sum }_{k = 1}^{N} {\sum }_{j = 1}^{{N}_{a}} [ \begin{matrix}0 & … & 0 & 0 & 0 & … & 0 & 0 & I / {NN}_{a} \\ 0 & … & {F}_{- τ ( j , k , p )} & {F}_{1 - τ ( j , k , p )} & {F}_{2 - τ ( j , k , p )} & … & 0 & 0 & 0 \\ 0 & … & {G}_{- τ ( j , k , p )} & {G}_{1 - τ ( j , k , p )} & {G}_{2 - τ ( j , k , p )} & ⋱ & ⋮ & 0 & 0 \\ ⋮ & ⋱ & ⋮ & ⋮ & ⋮ & ⋱ & ⋮ & ⋮ & ⋮ \\ 0 & … & 0 & 0 & 0 & … & {F}_{2 i - τ ( j , k , p )} & {F}_{2 i + 1 - τ ( j , k , p )} & {F}_{2 i + 2 - τ ( j , k , p )} \\ 0 & … & 0 & 0 & 0 & … & {G}_{2 i - τ ( j , k , p )} & {G}_{2 i + 1 - τ ( j , k , p )} & {G}_{2 i + 2 - τ ( j , k , p )} \\ ⋮ & ⋱ & ⋮ & ⋮ & ⋮ & ⋱ & ⋮ & ⋮ & ⋮ \\ 0 & … & 0 & 0 & 0 & … & 0 & 0 & 0\end{matrix} ] \\ and \\ {P}_{2} = {\sum }_{k = 1}^{N} {\sum }_{j = 1}^{{N}_{a}} [ \begin{matrix}0 & 0 & 0 & … & 0 & 0 & 0 & … & 0 \\ ⋮ & ⋮ & ⋮ & ⋱ & ⋮ & ⋮ & ⋮ & … & 0 \\ {F}_{2 i + 2 - τ ( j , k , p )} & {F}_{2 i + 3 - τ ( j , k , p )} & {F}_{2 i + 4 - τ ( j , k , p )} & … & 0 & 0 & 0 & … & 0 \\ {G}_{2 i + 2 - τ ( j , k , p )} & {G}_{2 i + 3 - τ ( j , k , p )} & {G}_{2 i + 4 - τ ( j , k , p )} & ⋱ & 0 & 0 & 0 & … & 0 \\ 0 & 0 & ⋮ & ⋱ & 0 & 0 & 0 & … & 0 \\ ⋮ & ⋮ & ⋮ & ⋮ & ⋮ & ⋮ & ⋮ & ⋮ & ⋮ \\ 0 & 0 & 0 & … & {F}_{2 {i}_{m} - τ ( j , k , p )} & {F}_{2 {i}_{m} + 1 - τ ( j , k , p )} & {F}_{2 {i}_{m} + 2 - τ ( j , k , p )} & … & 0 \\ 0 & 0 & 0 & … & {G}_{2 {i}_{m} - τ ( j , k , p )} & {G}_{2 {i}_{m} + 1 - τ ( j , k , p )} & {G}_{2 {i}_{m} + 2 - τ ( j , k , p )} & … & 0\end{matrix} ] .\end{matrix}$$

Step 3 is:

construct transition matrix Φ of the milling system:

$$Φ = \{ \begin{matrix}{( {P}_{1} - {P}_{2} )}^{- 1} Q , if \vert {P}_{1} - {P}_{2} \vert \neq 0 \\ {( {P}_{1} - {P}_{2} )}^{†} Q , if \vert {P}_{1} - {P}_{2} \vert = 0\end{matrix} \qquad ( 15 )$$

where |P₁−P₂| denotes determinant of matrix (P₁−P₂); † denotes Moore-Penrose pseudoinverse of matrix (P₁−P₂); based on Floquet theory, stability of milling system depends on eigenvalue of Φ: it is stable if all modules of eigenvalues of Φ are less than 1; it is unstable otherwise.

Step 4 is:

based on fixed mapping point theorem, the state variable vector x(t) satisfies x(tᵢ)=x(tᵢ−T) for chatter-free cutting conditions; therefore, it has y_{[0,T]}=y_{[-T,0]}; state variables on all discrete points are calculated by:

$${y}^{*} = {y}_{[ 0 , T ]} = {y}_{[ - T , 0 ]} = \{ \begin{matrix}{( {P}_{1} - {P}_{2} - Q )}^{- 1} {z}_{[ 0 , T ]} , if \vert {P}_{1} - {P}_{2} - Q \vert \neq 0 \\ {( {P}_{1} - {P}_{2} - Q )}^{†} {z}_{[ 0 , T ]} , if \vert {P}_{1} - {P}_{2} - Q \vert = 0\end{matrix} \qquad ( 16 )$$

where y* consists of modal displacement vector Γ(tᵢ) and modal velocity vector \dot{Γ}(tᵢ) at all discrete time nodes i=0,1, . . . ,2iₘ30 2 during one rotation period of cutting tool.

Step 5 comprises sub-steps of:

step 5.1: transform modal displacements into physical space, and calculate relative vibration displacements q(tᵢ) between cutting tool and workpiece:

q(tᵢ)=q_{T}(tᵢ)−q_{W}(tᵢ)=P_{T}Γ_{T}(tᵢ)−P_{W}Γ_{W}(tᵢ) (17)

where q_{T}(tᵢ) and q_{W}(tᵢ) are vibration displacements of cutting tool and workpiece, respectively;

step 5.2: extract vibration displacements in direction normal to milled surface of workpiece (defined as \vec{Oy} direction) from q(tᵢ), which constructs a new vector Q_{y}*:

Q_{y}*={[q_{y}(t₁)]^{T},[q_{y}(t₂)]^{T}, . . . ,[q_{y}(t₂ᵢ_{ₘ}₊₂)]^{T}} (18)

extract vibration displacements in feed direction (defined as \vec{Ox} direction), which constructs a new vector Qₓ*:

Qₓ*={[qₓ(t₁)]^{T},[qₓ(t₂)]^{T}, . . . ,[qₓ(t₂ᵢ_{ₘ}₊₂)]^{T}} (19)

step 5.3: based on kinematic synthesis of relative feed movement between cutting tool and workpiece, rotation of cutting tool and relative vibrations between cutting tool and workpiece, calculate motion trajectories in \vec{Oy} direction and \vec{Ox} direction for cutting element (j,k), respectively, as shown in FIG. 1 (a):

$${Θ}_{y}^{*} ( i , j , k ) = {\underbrace{\frac{f \cdot {t}_{i}}{1000 \times 60} sin ( {φ}_{fy} )}}_{feed} - {\underbrace{\begin{matrix}R ( j , k ) cos ( {φ}_{ref} - ϕ ( j , k ) - \frac{{z}_{j} tan ( {β}_{k} )}{R} & + 2 π \frac{Ω {t}_{i}}{60} )\end{matrix}}}_{rotation} + {\underbrace{\begin{matrix}{Q}_{y}^{*} & ( i , j )\end{matrix}}}_{vibration} \qquad ( 20 )$$

$${Θ}_{x}^{*} ( j , k , i ) = {\underbrace{\begin{matrix}\frac{f \cdot {t}_{i}}{1000 \times 60} & cos ( {φ}_{fy} )\end{matrix}}}_{feed} + {\underbrace{R ( j , k ) sin ( {φ}_{ref} + ϕ ( j , k ) - \frac{{z}_{j} tan ( {β}_{k} )}{R} + \frac{60 {t}_{i}}{Ω} )}}_{rotation} + {\underbrace{\begin{matrix}{Q}_{x}^{*} & ( j , i )\end{matrix}}}_{vibrations} \qquad ( 21 )$$

where f is relative feed rate between cutting tool and workpiece in mm/min; φ_{fy} is angle between feed direction of cutting tool and normal direction of workpiece; R(j,k) is actual cutting radius of cutting element (j,k); q); φ_{ref} is reference angle used in the Generalized Runge-Kutta method; ϕ(j,k) is pitch angle between Tooth k and Tooth 1 for j-th discrete axial slice; βₖ is helix angle with regard to Tooth k; zⱼ is axial height of j-th discrete axial slice; R is geometric radius of cutting tool; Ω is spindle rotation speed; Q_{y}*(j,i) and Qₓ*(j,i) are vibration displacements of cutting element (j,k) in \vec{Oy} and \vec{Ox} directions, respectively.

Step 6 comprises sub-steps of:

step 6.1: select part of motion trajectories of cutting tool that are near milled surface of workpiece based on following equation, which construct motion trajectory points to be densified with interpolation, i.e., (Θ_{x_trim}*(j,k,i), Θ_{y_trim}*(j,k,i)):

Θ_{y}*(j,k,i)≥max{Θ_{y}*(j,k,i)}−αR, down-milling

Θ_{y}*(j,k,i)≤min{Θ_{y}*(j,k,i)}+αR, up-milling

where α is a coefficient to adjust selecting range;

step 6.2: determine lower and upper limits of the selected trajectory points in \vec{Ox} direction, i.e., xₘᵢₙ=min {Θ_{x_trim}*(j,k,i)} and xₘₐₓ=max {Θ_{x_trim}*(j,k,i)}; discretize interval [xₘᵢₙ,xₘₐₓ] equally with a step δx to obtain x coordinate set of interpolation points {xₘᵢₙ,xₘᵢₙ+δx, xₘᵢₙ+2·δx, . . . ,xₘₐₓ}, where number of points is denoted by Nₛ;

step 6.3: taking the selected points (Θ_{x_trim}*(j,k,i), Θ_{y_trim}*(j,k,i)) in step 6.1 as known points, use spline interpolation algorithm to determine y coordinates of interpolation points with regard to x coordinates {xₘᵢₙ,xₘᵢₙ+δx,xₘᵢₙ+2·δx, . . . ,xₘₐₓ}, which results in densified motion trajectories of cutting tool edges during one rotation period T of cutting tool, i.e., (xₛ(l), yₛ (l)),l=1, 2, . . . Nₛ, as shown in FIG. 1 (b);

step 6.4: based on periodicity of chatter-free milling dynamic responses, i.e., xₛ(l) and xₛ(l)+nᵣₑᵥT share same y coordinate yₛ(l), obtain densified motion trajectory points of cutting tool during nᵣₑᵥ rotation periods of cutting tool, i.e., (x_{s_n_trim}(l), y_{s_n_trim}(l)), l=1, 2, . . . N_{s_n_trim}, where N_{s_n_trim} is number of interpolation points on nᵣₑᵥ rotation periods of cutting tool, and nᵣₑᵥ≥4, as shown in FIG. 1 (c);

step 6.5: select densified motion trajectory points of cutting tool edges on middle periods that satisfy xₘᵢₙ, +T≤x_{s_n}(l)≤nᵣₑᵥ·xₘₐₓ−T to construct a new densified point set (x_{s_n_trim}(l), y_{s_n_trim}(l)), l=1, 2, N_{s_n_trim}, where N_{s_n_trim} is number of trimmed interpolation points;

step 6.6: sort the selected set (x_{s_n_trim} (l), y_{s_n_trim}(l)) in order of axial height to construct Nₐ sub-sets of densified points, i.e., (x_{s_n_trim}(j,l), y_{s_n_trim}(j,l), j=1, 2, . . . ,Nₐ;

step 6.7: at each axial height, compare values of y coordinates for all teeth that have same x coordinate; based on following equation, select densified points that are nearest to milled surface of workpiece to construct final surface topography points of workpiece (x_{surf}(j,l), y_{surf}(j,l)), l=1,2, . . . N_{s_n_trim}, shown in FIG. 1 (d) and FIG. 2 (b):

$$\begin{matrix}{y}_{surf} ( j , l ) = {max}_{k} \{ {y}_{s \_ n \_ trim} ( j , l ) \} , down - milling \\ {y}_{surf} ( j , l ) = {min}_{k} \{ {y}_{s \_ n \_ trim} ( j , l ) \} , up - milling\end{matrix}$$

Step 7 is:

calculate surface location error (SLE) based on motion trajectories Θ_{y}*(i,j,k) in normal direction of workpiece; surface location error SLE(j,k) with regard to cutting element (j,k) is:

$$SLE ( j , k ) = \{ \begin{matrix}{max}_{i} \{ {Θ}_{y}^{*} ( j , k , i ) \vert 1 \leq i \leq 2 {i}_{m} + 2 \} - D / 2 , down - milling \\ - {min}_{i} \{ {Θ}_{y}^{*} ( j , k , i ) \vert 1 \leq i \leq 2 {i}_{m} + 2 \} - D / 2 , up - milling\end{matrix} \qquad ( 22 )$$

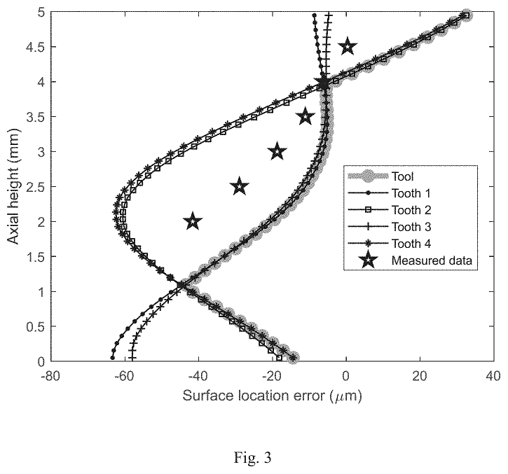

surface location error with regard to axial height zⱼ is:

$$SLE ( j ) = \{ \begin{matrix}{max}_{i , k} \{ {Θ}_{y}^{*} ( j , k , i ) \vert 1 \leq i \leq 2 {i}_{m} + 2 , 1 \leq k \leq N \} - D / 2 , down - milling \\ - {min}_{i , k} \{ {Θ}_{y}^{*} ( j , k , i ) \vert 1 \leq i \leq 2 {i}_{m} + 2 , 1 \leq k \leq N \} - D / 2 , up - milling\end{matrix} \qquad ( 23 )$$

where positive value mean overcut, and negative value mean undercut, as shown in FIG. 3.

Step 8 is:

based on points (x_{surf} (j,l), y_{surf}(j,l)) that participate in generating surface topography of workpiece, surface roughness is calculated by:

$$Ra ( j ) = \frac{1}{{N}_{s\_n \_trim}} {\sum }_{{i}^{′} = 1}^{{N}_{s \_ n \_ trim}} \vert {y}_{surf} ( j , l ) - {\overline{y}}_{surf} ( j , l ) \vert \qquad ( 24 )$$

An experimental example is presented to further illustrate the invented method. The geometric parameters of cutting tool are: diameter D=12 mm, number of teeth N=4, pitch angles 80°-100°-80°-100°, and helix angles 45°-45°-45°-45°. The cutting parameters are: spindle rotation speed Ω=2500 rpm, radial depth of cut aᵣ=0.5 mm, axial depth of cut aₚ=5 mm, and feed per revolution fᵣₑᵥ=0.2 mm/rev. The system dynamic parameters are: natural frequency fₙ=189.1 Hz, damping ratio [symbol] =0.0047, and stiffness k=3.01×10⁶ N/m. The runout parameters are: offset value ρ=2.5 μm, and orientation angle λ=0.1°.

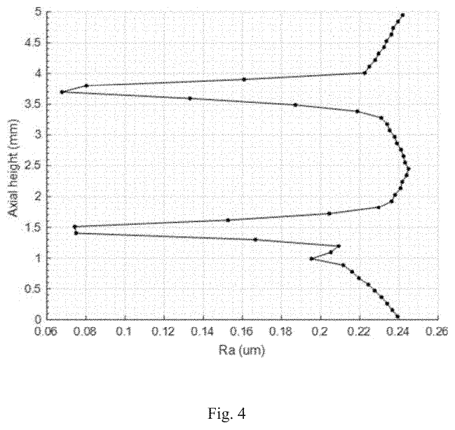

With the provided parameters, milled surface topography can be simulated by following the procedures in steps 1˜7, as illustrated in FIG. 2. According to microphotography in FIG. 2(b), the simulated surface topography matches milled surface topography well. Simulated and measured surface location errors are illustrated in FIG. 3, where positive value means overcut and negative value means undercut. According to FIG. 3, the simulated surface location errors locate in the range between −43.5 μm and 32.6 μm. Selecting six points along axial height of cutting tool, measured surface location errors using Coordinate Measurement Machine are −41.6 μm, −29.0 μm, −18.7 μm, −11.1 μm, −6.2 μm and 0.3 μm, which validate the simulated results. As shown in FIG. 4, the predicted surface roughness locates in the range between 0.0679 μm and 0.2449 μm. Selecting four points along axial height of cutting tool, measured surface roughness values are Rₐ=0.2190 μm, Rₐ=0.2865 μm, Rₐ=0.2395 μm and Rₐ=0.2665 μm, which validate the simulated results.

This invention can be embodied in other forms without departing from the spirit or essential attributes thereof and, accordingly, reference should be had to the claims rather than the foregoing specification as indicating the scope of the invention.

1. A method for simulating chatter-free milled surface topography, comprising steps of:
step 1: performing dynamics modeling on milling system and building a delay differential equation with multiple delays to represent dynamic model;
step 2: constructing state transition matrix between two adjacent cutting tool rotation periods by extending Generalized Runge-Kutta method;
step 3: predicting stable milling parameter zones based on Floquet theory;
step 4: calculating vibration displacements on discretized time nodes during one cutting tool rotation period by means of fixed mapping point theorem;
step 5: constructing motion trajectories of cutting tool edges in normal and feed directions with regard to milled surface of workpiece;
step 6: predicting surface topography of workpiece by using spline interpolation to densify motion trajectories of cutting tool edges that participate in generating final surface of workpiece;
step 7: calculating surface location error of milled surface based on motion trajectories of cutting tool edges in normal direction with regard to milled surface of workpiece;
step 8: calculating surface roughness based on the simulated surface topography of workpiece.

2. The method for simulating chatter-free milled surface topography of claim 1, wherein the step 1 comprises sub-steps of:
step 1.1: considering flexibility of both cutting tool and workpiece, variance of pitch angles and helix angles of cutting tool, and teeth runout, performing dynamics modeling on milling system and building a delay differential equation with multiple delays to represent the dynamic model in physical space:
$$M \ddot{q} ( t ) + C \dot{q} ( t ) + Kq ( t ) = {\sum }_{k = 1}^{N} {\sum }_{j = 1}^{{N}_{a}} \{ {K}_{c} ( t , j , k ) [ q ( t ) - q ( t - {\sum }_{p = {k}_{v}}^{k} τ ( j , p ) ) ] + {F}_{0} ( t , j , k ) \}$$
where M C and K are mass, damping and stiffness matrices, respectively; \ddot{q}(t), \dot{q}(t) and q(t) are acceleration, velocity and displacement vectors at time t, respectively; K_{c}(t,j,k) is directional coefficient matrix for Tooth k at j-th axial slice at time t; F₀(t,j,k) is cutting force vector for Tooth k at j-th axial slice at time t, which is independent of chip regeneration; Σₚ₌ₖ^{k}τ(j,p) is time delay with regard to cutting element (j,k) is mathematical summation operator, p is a variable for summation, and is tooth serial number to start delay calculation; N is number of teeth; and Nₐ is number of axial discretization of tool;
step 1.2: performing modal coordinate transformation on the dynamic model in step 1.1, which can be transformed from physical space into modal space; the modal coordinate transformation equation is:
q(t)=PΓ(t)
where P is mode shape matrix, and Γ(t) is modal displacement vector at time t;
dynamics model in modal space which is represented with delay differential equation with multiple delays turns out to be:
$${M}_{Γ} \ddot{Γ} ( t ) + {C}_{Γ} \dot{Γ} ( t ) + {K}_{Γ} Γ ( t ) = {\sum }_{k = 1}^{N} {\sum }_{j = 1}^{{N}_{a}} \{ {P}^{T} {K}_{c} ( t , j , k ) P [ Γ ( t ) - Γ ( t - {\sum }_{p = {k}_{v}}^{k} τ ( j , p ) ) ] + {P}^{T} {F}_{0} ( t , j , k ) \}$$
where M_{Γ}, C_{Γ} and K_{Γ} are modal mass, modal damping and modal stiffness matrices, respectively; \ddot{Γ}(t), \dot{Γ}(t) and Γ(t) are modal acceleration, modal velocity and modal displacement vectors, respectively;
for milling system with flexible cutting tool and flexible workpiece, the dynamic model becomes:
$$\begin{matrix}[ \begin{matrix}{M}_{Γ ; T} & \\ & {M}_{Γ ; W}\end{matrix} ] \{ \begin{matrix}{\ddot{Γ}}_{T} ( t ) \\ {\ddot{Γ}}_{W} ( t )\end{matrix} \} + [ \begin{matrix}{C}_{Γ ; T} & \\ & {C}_{Γ ; W}\end{matrix} ] \{ \begin{matrix}{\dot{Γ}}_{T} ( t ) \\ {\dot{Γ}}_{W} ( t )\end{matrix} \} + [ \begin{matrix}{K}_{Γ ; T} & \\ & {K}_{Γ ; W}\end{matrix} ] \{ \begin{matrix}{Γ}_{T} ( t ) \\ {Γ}_{W} ( t )\end{matrix} \} = \\ {\sum }_{k = 1}^{N} {\sum }_{j = 1}^{{N}_{a}} \{ [ \begin{matrix}{P}_{T}^{T} \\ - {P}_{W}^{T}\end{matrix} ] {K}_{c} ( t , j , k ) \begin{matrix}[ {P}_{T} & - {P}_{W} ] \{ \begin{matrix}{Γ}_{T} ( t ) - {Γ}_{T} ( t - {\sum }_{p = {k}_{v}}^{k} τ ( j , p ) ) \\ {Γ}_{W} ( t ) - {Γ}_{W} ( t - {\sum }_{p = {k}_{v}}^{k} τ ( j , p ) )\end{matrix} \}\end{matrix} + [ \begin{matrix}{P}_{T}^{T} \\ - {P}_{W}^{T}\end{matrix} ] {F}_{0} ( t , j , k ) \}\end{matrix}$$
where M_{Γ;T}, C_{Γ;T} and K_{Γ;T} are modal mass, modal damping and modal stiffness matrices of cutting tool; M_{Γ;W}, C_{Γ;W} and K_{Γ;W} are modal mass; modal damping and modal stiffness matrices of workpiece; \ddot{Γ}_{T}(t), \dot{Γ}_{T} (t) and Γ_{T}(t) are modal acceleration, modal velocity and modal displacement vectors of cutting tool; \ddot{Γ}_{W}(t), Γ_{W}(t) and Γ_{W}(t) are modal acceleration, modal velocity and modal displacement vectors of workpiece; P_{T}, and P_{W} are mode shape matrices of cutting tool and workpiece, respectively; P_{T}^{T} and P_{W}^{T} are transposed matrices P_{T} and P_{W}, respectively;
for milling system with flexible cutting tool and rigid workpiece, the dynamic model becomes:
$$\begin{matrix}{M}_{Γ ; T} {\ddot{Γ}}_{T} ( t ) + {C}_{Γ ; T} {\dot{Γ}}_{T} ( t ) + {K}_{Γ ; T} {Γ}_{T} ( t ) = \\ {\sum }_{k = 1}^{N} {\sum }_{j = 1}^{{N}_{a}} \{ {P}_{T}^{T} {K}_{c} ( t , j , k ) \{ {P}_{T} [ {Γ}_{T} ( t ) - {Γ}_{T} ( t - {\sum }_{p = {k}_{v}}^{k} τ ( j , p ) ) ] \} + {P}_{T}^{T} {F}_{0} ( t , j , k ) \}\end{matrix}$$
for milling system with rigid cutting tool and flexible workpiece, the dynamic model becomes:
$$\begin{matrix}{M}_{Γ ; W} {\ddot{Γ}}_{W} ( t ) + {C}_{Γ ; W} {\dot{Γ}}_{W} ( t ) + {K}_{Γ ; W} {Γ}_{W} ( t ) = \\ {\sum }_{k = 1}^{N} {\sum }_{j = 1}^{{N}_{a}} \{ {P}_{W}^{T} {K}_{c} ( t , j , k ) \{ {P}_{W} [ {Γ}_{W} ( t ) - {Γ}_{W} ( t - {\sum }_{p = {k}_{v}}^{k} τ ( j , p ) ) ] \} - {P}_{W}^{T} {F}_{0} ( t , j , k ) \} .\end{matrix}$$

3. The method for simulating chatter-free milled surface topography of claim 1, wherein the step 2 comprises sub-steps of:
step 2.1: performing state space transformation on the dynamic model in modal space by introducing state variable vector x(t)=[(Γ(t))^{T},(\dot{Γ}(t))^{T}]^{T}, and delay differential equation with multiple delays in state space becomes:
$$\dot{x} ( t ) = Ax ( t ) + {\sum }_{k = 1}^{N} {\sum }_{j = 1}^{{N}_{a}} \{ B ( t , j , k ) [ x ( t ) - x ( t - {\sum }_{p = {\overline{k}}_{v}}^{k} τ ( j , p ) ) ] + D ( t , j , k ) \}$$
where x(t) denotes state variable vector, \dot{x}(t) denotes first derivative of x(t) with regard to time t,
$$A = [ \begin{matrix}0 & I \\ - {M}_{Γ}^{- 1} {K}_{Γ} & - {M}_{Γ}^{- 1} {C}_{Γ}\end{matrix} ] ,$$
$$B ( t , j , k ) = [ \begin{matrix}0 & 0 \\ {M}_{Γ}^{- 1} {P}^{T} {K}_{c} ( t , j , k ) P & 0\end{matrix} ] ,$$
$$D ( t , j , k ) = [ \begin{matrix}0 \\ {M}_{Γ}^{- 1} {P}^{T} {F}_{0} ( t , j , k )\end{matrix} ] ,$$
and I is unit matrix;
step 2.2: dividing one rotation period of cutting tool T into 2iₘ+2 equal intervals with a series of discrete nodes {t₀,t₁, . . . t₂ᵢ_{ₘ}₊₂}; analytical expression of dynamic responses at interval [tᵢ,t] with regard to the delay differential equation with multiple delays in step 2.1 is:
$$x ( t ) = {e}^{A ( τ - {t}_{i} )} x ( {t}_{i} ) + {\sum }_{k = 1}^{N} {\sum }_{j = 1}^{{N}_{a}} {\int }_{{t}_{i}}^{t} \{ {e}^{A ( t - ξ )} B ( ξ , j , k ) [ x ( ξ ) - x ( ξ - {\sum }_{p = {k}_{v}}^{k} τ ( j , p ) ) ] + {e}^{A ( t - ξ )} D ( ξ , j , k ) \} d ξ$$
where ξ is integration variable;
for brevity, define xᵢ:=x(tᵢ), E(t,tᵢ):=e^{A(t-t}^{ᵢ}⁾x(tᵢ), H_{j,k}(t,ξ,x(ξ)):=e^{A(t-ξ)}B(ξ,j,k)[x(ξ)−x(ξ−τ(j,k,p))] and J_{j,k}(t,ξ):=e^{A(t+ξ)}D(ξ,j,k);
on sub-interval [t₂ᵢ,t₂ᵢ₊₂], x(t) is approximated using Simpson's rule:
$${x}_{2 i + 2} = E ( {t}_{2 i + 2} , {t}_{2 i} ) + \frac{h}{3} {\sum }_{k = 1}^{N} {\sum }_{j = 1}^{{N}_{a}} \{ {H}_{j , k} ( {t}_{2 i + 2} , {t}_{2 i} , {x}_{2 i} ) + 4 {H}_{j , k} ( {t}_{2 i + 2} , {t}_{2 i + 1} , {x}_{2 i + 1} ) + {H}_{j , k} ( {t}_{2 i + 2} , {t}_{2 i + 2} , {x}_{2 i + 2} ) + {J}_{j , k} ( {t}_{2 i + 2} , {t}_{2 i} ) + 4 {J}_{j , k} ( {t}_{2 i + 2} , {t}_{2 i + 1} ) + {J}_{j , k} ( {t}_{2 i + 2} , {t}_{2 i + 2} ) \}$$
on sub-interval [t₂ᵢ,t₂ᵢ₊₁], x(i) is approximated using fourth-order Runge-Kutta algorithm:
$${x}_{2 i + 1} = E ( {t}_{2 i + 1} , {t}_{2 i} ) + \frac{h}{6} {\sum }_{k = 1}^{N} {\sum }_{j = 1}^{{N}_{a}} \{ {H}_{j , k} ( {t}_{2 i + 1} , {t}_{2 i} , {x}_{2 i} ) + 2 {H}_{j , k} ( {t}_{2 i + 1} , {t}_{2 i + 1 / 2} , {x}_{2 i + 1 / 2} ) + 2 {H}_{j , k} ( {t}_{2 i + 1} , {t}_{2 i + 1 / 2} , {x}_{2 i + 1 / 2} ) + {H}_{j , k} ( {t}_{2 i + 1} , {t}_{2 i + 1} , {x}_{2 i + 1} ) + {J}_{j , k} ( {t}_{2 i + 1} , {t}_{2 i} ) + 2 {J}_{j , k} ( {t}_{2 i + 1} , {t}_{2 i + 1 / 2} ) + 2 {J}_{j , k} ( {t}_{2 i + 1} , {t}_{2 i + 1 / 2} ) + {J}_{j , k} ( {t}_{2 i + 1} , {t}_{2 i + 1} ) \}$$
where state variable vector at middle points t_{2i+1/2} is approximated with Lagrange formula:
x_{2i+1/2}=⅜x₂ᵢ+¾x₂ᵢ₋₁−⅛x₂ᵢ₊₂
re-organizing the analytical expression of dynamic responses on sub-interval [t₂ᵢ,t₂ᵢ₊₂] into:
$${F}_{2 i} {x}_{2 i} + {F}_{2 i + 1} {x}_{2 i + 1} + {F}_{2 i + 2} {x}_{2 i + 2} = {\sum }_{k = 1}^{N} {\sum }_{j = 1}^{{N}_{a}} ( {F}_{2 i - τ ( j , k )} {x}_{2 i - τ ( j , k )} + {F}_{2 i + 1 - τ ( j , k )} {x}_{2 i + 1 - τ ( j , k )} + {F}_{2 i + 2 - τ ( j , k )} {x}_{2 i + 2 - τ ( j , k )} ) + {\sum }_{k = 1}^{N} {\sum }_{j = 1}^{{N}_{a}} ( {S}_{2 i} + {S}_{2 i + 1 / 2} + {S}_{2 i + 1} )$$
$$where$$
$${F}_{2 i} = - {e}^{Ah} - \frac{h}{6} {e}^{Ah} {\sum }_{k = 1}^{N} {\sum }_{j = 1}^{{N}_{a}} {B}_{2 i , j , k} - \frac{3}{8} \cdot \frac{4 h}{6} {e}^{Ah / 2} {\sum }_{k = 1}^{N} {\sum }_{j = 1}^{{N}_{a}} {B}_{2 i + 1 / 2 , j , k} ,$$
$${F}_{2 i + 1} = I - \frac{3}{4} \cdot \frac{4 h}{6} {e}^{Ah / 2} {\sum }_{k = 1}^{N} {\sum }_{j = 1}^{{N}_{a}} {B}_{2 i + 1 / 2 , j , k} - \frac{h}{6} {\sum }_{k = 1}^{N} {\sum }_{j = 1}^{{N}_{a}} {B}_{2 i + 1 , j , k} ,$$
$${F}_{2 i + 2} = \frac{1}{8} \cdot \frac{4 h}{6} {e}^{Ah / 2} {\sum }_{k = 1}^{N} {\sum }_{j = 1}^{{N}_{a}} {B}_{2 i + 1 / 2 , j , k} ,$$
$${F}_{2 i - τ ( j , k , p )} = - \frac{h}{6} {e}^{Ah} {B}_{2 i , j , k} - \frac{3}{8} \cdot \frac{4 h}{6} {e}^{Ah / 2} {B}_{2 i + 1 / 2 , j , k} ,$$
$${F}_{2 i + 1 - τ ( j , k , p )} = - \frac{3}{4} \cdot \frac{4 h}{6} {e}^{Ah / 2} {B}_{2 i + 1 / 2 , j , k} - \frac{h}{6} {B}_{2 i + 1 , j , k} ,$$
$${F}_{2 i + 2 - τ ( j , k , p )} = \frac{1}{8} \cdot \frac{4 h}{6} {e}^{Ah / 2} {B}_{2 i + 1 / 2 , j , k} ,$$
$${S}_{2 i} = \frac{h}{6} {e}^{A \cdot h} {D}_{2 i , j , k} ,$$
$${S}_{2 i + 1 / 2} = \frac{h}{6} \cdot 4 {e}^{A \cdot h / 2} {D}_{2 i + 1 / 2 , j , k} ,$$
$${S}_{2 i + 1} = \frac{h}{6} {D}_{2 i + 1 , j , k} ,$$
and h is the discretization step;
re-organizing the analytical expression of dynamic responses on sub-interval [t₂ᵢ,t₂ᵢ₊₂] into:
$${G}_{2 i} {x}_{2 i} + {G}_{2 i + 1} {x}_{2 i + 1} + {G}_{2 i + 2} {x}_{2 i + 2} = {\sum }_{k = 1}^{N} {\sum }_{j = 1}^{{N}_{a}} ( {G}_{2 i - τ ( j , k )} {x}_{2 i - τ ( j , k )} + {G}_{2 i + 1 - τ ( j , k )} {x}_{2 i + 1 - τ ( j , k )} + {G}_{2 i + 2 - τ ( j , k )} {x}_{2 i + 2 - τ ( j , k )} ) + {\sum }_{k = 1}^{N} {\sum }_{j = 1}^{{N}_{a}} ( {T}_{2 i} + {T}_{2 i + 1} + {T}_{2 i + 2} )$$
$$where$$
$${G}_{2 i} = - {e}^{2 Ah} - \frac{h}{3} {e}^{2 Ah} {\sum }_{k = 1}^{N} {\sum }_{j = 1}^{{N}_{a}} {B}_{2 i , j , k} ,$$
$${G}_{2 i + 1} = - \frac{4 h}{3} {e}^{A h} {\sum }_{k = 1}^{N} {\sum }_{j = 1}^{{N}_{a}} {B}_{2 i + 1 , j , k} ,$$
$${G}_{2 i + 2} = I - \frac{h}{3} {\sum }_{k = 1}^{N} {\sum }_{j = 1}^{{N}_{a}} {B}_{2 i + 2 , j , k} ,$$
$${G}_{2 i - τ ( j , k , p )} = - \frac{h}{3} {e}^{2 A h} {B}_{2 i , j , k} ,$$
$${G}_{2 i + 1 - τ ( j , k , p )} = - \frac{4 h}{3} {e}^{A h} {B}_{2 i + 1 , j , k} ,$$
$${G}_{2 i + 2 - τ ( j , k , p )} = - \frac{h}{3} {B}_{2 i + 2 , j , k} ,$$
$${T}_{2 i} = \frac{h}{3} {e}^{A \cdot 2 h} {D}_{2 i , j , k} ,$$
$${T}_{2 i + 1} = \frac{h}{3} \cdot 4 {e}^{A \cdot h} {D}_{2 i + 1 , j , k}$$
$$and$$
$${T}_{2 i + 2} = \frac{h}{3} {D}_{2 i + 2 , j , k} ;$$
step 2.3: based on the formulae in step 2.2, establishing discrete mapping relationship between two adjacent rotation periods of cutting tool [−T,0] and [0,T]:
$${P}_{1} {y}_{[ 0 , T ]} = {Qy}_{[ - T , 0 ]} + {P}_{2} {y}_{[ 0 , T ]} + {z}_{[ 0 , T ]}$$
$$where$$
$${y}_{[ 0 , T ]} = [ \begin{matrix}{x}_{0} \\ {x}_{1} \\ {x}_{2} \\ {x}_{3} \\ {x}_{4} \\ ⋮ \\ {x}_{2 {i}_{m} + 1} \\ {x}_{2 {i}_{m} + 2}\end{matrix} ] , {y}_{[ - T , 0 ]} = [ \begin{matrix}{x}_{0 - T} \\ {x}_{1 - T} \\ {x}_{2 - T} \\ {x}_{3 - T} \\ {x}_{4 - T} \\ ⋮ \\ {x}_{2 {i}_{m} + 1 - T} \\ {x}_{2 {i}_{m} + 2 - T}\end{matrix} ] , {z}_{[ 0 , T ]} = {\sum }_{k = 1}^{N} {\sum }_{j = 1}^{{N}_{a}} [ \begin{matrix}0 \\ {S}_{0} + {S}_{1 / 2} + {S}_{1} \\ {T}_{0} + {T}_{1} + {T}_{2} \\ {S}_{2} + {S}_{2 + 1 / 2} + {S}_{3} \\ {T}_{2} + {T}_{3} + {T}_{4} \\ ⋮ \\ {S}_{2 {i}_{m}} + {S}_{2 {i}_{m} + 1 / 2} + {S}_{2 {i}_{m} + 1} \\ {T}_{2 {i}_{m}} + {T}_{2 {i}_{m} + 1} + {T}_{2 {i}_{m} + 2}\end{matrix} ] ,$$
$${P}_{1} = [ \begin{matrix}I & 0 & 0 & 0 & 0 & … & 0 & 0 & 0 \\ {F}_{0} & {F}_{1} & {F}_{2} & 0 & 0 & … & 0 & 0 & 0 \\ {G}_{0} & {G}_{1} & {G}_{2} & 0 & 0 & … & 0 & 0 & 0 \\ 0 & 0 & {F}_{2} & {F}_{3} & {F}_{4} & … & 0 & 0 & 0 \\ 0 & 0 & {G}_{2} & {G}_{3} & {G}_{4} & … & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & … & {F}_{2 {i}_{m}} & {F}_{2 {i}_{m} + 1} & {F}_{2 {i}_{m} + 2} \\ 0 & 0 & 0 & 0 & 0 & … & {G}_{2 {i}_{m}} & {G}_{2 {i}_{m} + 1} & {G}_{2 {i}_{m} + 2}\end{matrix} ] ,$$
$$Q = {\sum }_{k = 1}^{N} {\sum }_{j = 1}^{{N}_{a}} [ \begin{matrix}0 & … & 0 & 0 & 0 & … & 0 & 0 & I / {NN}_{a} \\ 0 & … & {F}_{- τ ( j , k , p )} & {F}_{1 - τ ( j , k , p )} & {F}_{2 - τ ( j , k , p )} & … & 0 & 0 & 0 \\ 0 & … & {G}_{- τ ( j , k , p )} & {G}_{1 - τ ( j , k , p )} & {G}_{2 - τ ( j , k , p )} & ⋱ & ⋮ & 0 & 0 \\ ⋮ & ⋱ & ⋮ & ⋮ & ⋮ & ⋱ & ⋮ & ⋮ & ⋮ \\ 0 & … & 0 & 0 & 0 & … & {F}_{2 i - τ ( j , k , p )} & {F}_{2 i + 1 - τ ( j , k , p )} & {F}_{2 i + 2 - τ ( j , k , p )} \\ 0 & … & 0 & 0 & 0 & … & {G}_{2 i - τ ( j , k , p )} & {G}_{2 i + 2 - τ ( j , k , p )} & {G}_{2 i + 2 - τ ( j , k , p )} \\ ⋮ & ⋱ & ⋮ & ⋮ & ⋮ & ⋱ & ⋮ & ⋮ & ⋮ \\ 0 & … & 0 & 0 & 0 & … & 0 & 0 & 0\end{matrix} ]$$
$$and$$
$${P}_{2} = {\sum }_{k = 1}^{N} {\sum }_{j = 1}^{{N}_{a}} [ \begin{matrix}0 & 0 & 0 & … & 0 & 0 & 0 & … & 0 \\ ⋮ & ⋮ & ⋮ & ⋱ & ⋮ & ⋮ & ⋮ & … & 0 \\ {F}_{2 i + 2 + τ ( j , k , p )} & {F}_{2 i + 3 + τ ( j , k , p )} & {F}_{2 i + 4 - τ ( j , k , p )} & … & 0 & 0 & 0 & … & 0 \\ {G}_{2 i + 2 - τ ( j , k , p )} & {G}_{2 i + 3 - τ ( j , k , p )} & {G}_{2 i + 4 - τ ( j , k , p )} & ⋱ & 0 & 0 & 0 & … & 0 \\ 0 & 0 & ⋮ & ⋱ & 0 & 0 & 0 & … & 0 \\ ⋮ & ⋮ & ⋮ & ⋮ & ⋮ & ⋮ & ⋮ & ⋮ & ⋮ \\ 0 & 0 & 0 & … & {F}_{2 {i}_{m} - τ ( j , k , p )} & {F}_{2 {i}_{m} + 1 - τ ( j , k , p )} & {F}_{2 {i}_{m} + 2 - τ ( j , k , p )} & … & 0 \\ 0 & 0 & 0 & … & {G}_{2 {i}_{m} - τ ( j , k , p )} & {G}_{2 {i}_{m} + 1 - τ ( j , k , p )} & {G}_{2 {i}_{m} + 2 - τ ( j , k , p )} & … & 0\end{matrix} ] .$$

4. The method for simulating chatter-free milled surface topography of claim 1, wherein the step 3 is:
constructing transition matrix Φ of the milling system:
$$Φ = \{ \begin{matrix}{( {P}_{1} - {P}_{2} )}^{- 1} Q , & if \vert {P}_{1} - {P}_{2} \vert \neq 0 \\ {( {P}_{1} - {P}_{2} )}^{†} Q , & if \vert {P}_{1} - {P}_{2} \vert = 0\end{matrix}$$
where |P₁−P₂| denotes determinant of matrix (P₁−P₂); † denotes Moore-Penrose pseudoinverse of matrix (P₁−P₂);
based on Floquet theory, stability of milling system depends on eigenvalue of Φ:it is stable if all modules of eigenvalues of Φ are less than 1; it is unstable otherwise.

5. The method for simulating chatter-free milled surface topography of claim 1, wherein the step 4 is:
based on fixed mapping point theorem, the state variable vector x(t) satisfies x(tᵢ)=x(tᵢ−T) for chatter-free cutting conditions; therefore, it has y_{[0,T]}=y_{-T,0}; calculating state variables on all discrete points by:
$${y}^{*} = {y}_{[ 0 , T ]} = {y}_{[ - T , 0 ]} = \{ \begin{matrix}{( {P}_{1} - {P}_{2} - Q )}^{- 1} {z}_{[ 0 , T ]} , & if \vert {P}_{1} - {P}_{2} - Q \vert \neq 0 \\ {( {P}_{1} - {P}_{2} - Q )}^{†} {z}_{[ 0 , T ]} , & if \vert {P}_{1} - {P}_{2} - Q \vert = 0\end{matrix}$$
where y* consists of modal displacement vector Γ(tᵢ) and modal velocity vector \dot{Γ}(tᵢ) at all discrete time nodes i=0,1, . . . ,2iₘ+2 during one rotation period of cutting tool.

6. The method for simulating chatter-free milled surface topography of claim 1, wherein the step 5 comprises sub-steps of:
step 5.1: transforming modal displacements into physical space, and calculating relative vibration displacements q(tᵢ) between cutting tool and workpiece:
q(tᵢ)=q_{T}(tᵢ)−q_{W}(tᵢ)=P_{T}Γ_{T}(tᵢ)−P_{W}Γ_{W}(tᵢ)
where q_{T} (tᵢ) and q_{W}(tᵢ) are vibration displacements of cutting tool and workpiece, respectively;
step 5.2: extracting vibration displacements in direction normal to milled surface of workpiece (defined as \vec{Oy} direction) from q(tᵢ), which constructs a new vector Q*_{y}:
Q_{y}*={[q_{y}(t₁)]T,[q_{y}(t₂)]^{T}, . . . ,[qₓ(t₂ᵢ_{ₘ}₊₂)]T}
extracting vibration displacements in feed direction (defined as \vec{Ox} direction), which constructs a new vector Q_{y}*:
Qₓ*={[qₓ(t₁)]^{T},[qₓ(t₂)]^{T}, . . . ,[qₓ(t₂ᵢ_{ₘ}₊₂)]T}
step 53: based on kinematic synthesis of relative feed movement between cutting tool and workpiece, rotation of cutting tool and relative vibrations between cutting tool and workpiece, calculating motion trajectories in \vec{Oy} direction and \vec{Ox} direction for cutting element (j,k), respectively:
$${Θ}_{y}^{*} ( i , j , k ) = {\underbrace{\frac{f \cdot {t}_{i}}{1000 \times 60} sin ( {φ}_{fy} )}}_{feed} - {\underbrace{R ( j , k ) cos ( {φ}_{ref} - ϕ ( j , k ) - \frac{{z}_{j} tan ( {β}_{k} )}{R} + 2 π \frac{Ω {t}_{i}}{60} )}}_{rotation} + {\underbrace{{Q}_{y}^{*} ( i , j )}}_{vibration}$$
$${Θ}_{y}^{*} ( j , k , i ) = {\underbrace{\frac{f \cdot {t}_{i}}{1000 \times 60} cos ( {φ}_{fy} )}}_{feed} + {\underbrace{R ( j , k ) sin ( {φ}_{ref} + ϕ ( j , k ) - \frac{{z}_{j} tan ( {β}_{k} )}{R} + \frac{60 {t}_{i}}{Ω} )}}_{rotation} + {\underbrace{{Q}_{x}^{*} ( j , i )}}_{vibrations}$$
where f is relative feed rate between cutting tool and workpiece in mm/min; φ_{fy} is angle between feed direction of cutting tool and normal direction of workpiece; R(j,k) is actual cutting radius of cutting element (j,k); φ_{ref} is reference angle used in the Generalized Runge-Kutta method; ϕ(j,k) is pitch angle between Tooth k and Tooth 1 for j-th discrete axial slice; βₖ is helix angle with regard to Tooth k; z_{f} is axial height of j-th discrete axial slice; R is geometric radius of cutting tool; Ω is spindle rotation speed; Q_{y}*(j,i) and Qₓ*(j,i) are vibration displacements of cutting element (j,k) in \vec{Oy} and \vec{Ox} directions, respectively.

7. The method for simulating chatter-free milled surface topography of claim 1, wherein the step 6 comprises sub-steps of:
step 6.1: selecting part of motion trajectories of cutting tool that are near milled surface of workpiece based on following equation, which construct motion trajectory points to be densified with interpolation, i.e., (Θ_{x_trim}*(j,k,i), Θ_{y_trim}*(j,k,i)):
Θ_{y}*(j,k,i)≥max{Θ_{y}*(j,k,i)}−αR, down-milling
Θ_{y}*(j,k,i)≤min{(Θ_{y}*(j,k,i)}+αR, up-milling
where α is a coefficient to adjust selecting range;
step 6.2: determining lower and upper limits of the selected trajectory points in \vec{Ox} direction, i.e., xₘᵢₙ=min{Θ_{x_trim}*(j,k,i)} and xₘₐₓ=max{Θ_{x_trim}*(j,k,i)}; discretize interval [xₘᵢₙ,xₘₐₓ] equally with a step δx to obtain x coordinate set of interpolation points {xₘᵢₙ, xₘᵢₙ+δx,xₘᵢₙ+2·δx, . . . ,xₘₐₓ}, where number of points is denoted by Nₛ;
step 6.3: taking the selected points (Θ_{x_trim}*(j,k,i), Θ_{y_trim}*(j,k,i)) in step 6.1 as known points, using spline interpolation algorithm to determine y coordinates of interpolation points with regard to x coordinates {xₘᵢₙ, xₘᵢₙ+δx,xₘᵢₙ+2·δx, . . . ,xₘₐₓ}, which results in densified motion trajectories of cutting tool edges during one rotation period T of cutting tool, i.e., (xₛ(l), yₛ(l)),l=1, 2 . . . Nₛ;
step 6.4: based on periodicity of chatter-free milling dynamic responses, i.e., xₛ(l) and xₛ(l)+nᵣₑᵥT share same y coordinate yₛ(l), obtaining densified motion trajectory points of cutting tool during nᵣₑᵥ rotation periods of cutting tool, i.e., (x_{s_n}(l), y_{s_n}(l)), l=1, 2, . . . N_{s_n}, where N_{s_n}, is number of interpolation points on nᵣₑᵥ rotation periods of cutting tool, and nᵣₑᵥ≥4;
step 6.5: selecting densified motion trajectory points of cutting tool edges on middle periods that satisfy xₘᵢₙ+T≤x_{s_n}(l)≤nᵣₑᵥ·xₘₐₓ−T to construct a new densified point set (x_{s_n_trim}(l), y_{s_n_trim}(l), l=1, 2, . . . N_{s_n_trim}, where N_{s_n_trim} is number of trimmed interpolation points;
step 6.6: sorting the selected set (x_{s_n_trim}(l), y_{s_n_trim}(l)), in order of axial height to construct Nₐ sub-sets of densified points, i.e., (x_{s_n_trim}(j,l), y_{s_n_trim}(j,l)), j=1,2, . . . ,Nₐ;
step 6.7: at each axial height, comparing values of v coordinates for all teeth that have same x coordinate; based on following equation, selecting densified points that are nearest to milled surface of workpiece to construct final surface topography points of workpiece (x_{surf}(j,l), y_{surf} (j,l)), l=1, 2, . . . N_{s_n_trim}:
$$\begin{matrix}{y}_{surf} ( j , l ) = {max}_{k} \{ {y}_{s\_n \_trim} ( j , l ) \} , & down - milling \\ {y}_{surf} ( j , l ) = {min}_{k} \{ {y}_{s\_n \_trim} ( j , l ) \} , & up - milling\end{matrix}$$

8. The method for simulating chatter-free milled surface topography of claim 1, wherein the step 7 is:
calculating surface location error (SLE) based on motion trajectories Θ_{y}*(i,j,k) in normal direction of workpiece; surface location error SLE(j,k) with regard to cutting element (j,k) is:
$$SLE ( j , k ) = \{ \begin{matrix}{max}_{i} \{ {Θ}_{y}^{*} ( j , k , i ) \vert 1 \leq i \leq 2 {i}_{m} + 2 \} - D / 2 , & down - milling \\ {- min}_{i} \{ {Θ}_{y}^{*} ( j , k , i ) \vert 1 \leq i \leq 2 {i}_{m} + 2 \} - D / 2 , & up - milling\end{matrix}$$
surface location error with regard to axial height zⱼ is:
$$SLE ( j ) = \{ \begin{matrix}{max}_{i , k} \{ {Θ}_{y}^{*} ( j , k , i ) \vert 1 \leq i \leq 2 {i}_{m} + 2 , 1 \leq k \leq N \} - D / 2 , & down - milling \\ {- min}_{i , k} \{ {Θ}_{y}^{*} ( j , k , i ) \vert 1 \leq i \leq 2 {i}_{m} + 2 , 1 \leq k \leq N \} - D / 2 , & up - milling\end{matrix}$$
where positive value mean overcut, and negative value mean undercut.

9. The method for simulating chatter-free milled surface topography of claim 1, wherein the step 8 is:
based on points (x_{surf}(j,l), y_{surf}(j,l), y_{surf}(j,l)) that participate in generating surface topography of workpiece, calculating surface roughness:
$$Ra ( j ) = \frac{1}{{N}_{s\_n \_trim}} {\sum }_{{i}^{′} = 1}^{{N}_{s\_n \_trim}} \vert {y}_{surf} ( j , l ) - {\overline{y}}_{surf} ( j , l ) \vert .$$
